(19) United States
(12) Patent Application Publication
(10) Pub. No.: US 2004/0117389 A1
(43) Pub. Date: Jun. 17, 2004

(54) Image forming system that can output documents stored in remote apparatus

(76) Inventors: Takashi Enami, Kanagawa (JP); Kazunori Hoshi, Kanagawa (JP); Takamasa Hayashi, Tokyo (JP); Yujin Mori, Kanagawa (JP); Shingo Shiramura, Kanagawa (JP); Yuuichi Mikuni, Tokyo (JP); Hidejirou Maehara, Kanagawa (JP); Yoshihiro Kuwabara, Saitama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/654,960

(22) Filed: Sep. 5, 2003

(30) Foreign Application Priority Data
Sep. 5, 2002 (JP) 2002-260430
Nov. 18, 2002 (JP) 2002-334007
Sep. 2, 2003 (JP) 2003-310252

(51) Int. Cl. G06F 7/00

(52) U.S. Cl. 707/100

(57) ABSTRACT

A file transfer system includes a file management server, a file transmitting terminal, and a file receiving terminal connected each other via a network. The file transmitting terminal transmits to the file management server a file and an authorization condition for accessing the file. The file management server stores the file and the authorization condition relating each other. The file receiving terminal transmits to the file management server a request for transferring the file. The file management server, in response to the request, determines whether the authorization condition is satisfied, and if the authorization condition is satisfied, transfers the file to the file receiving terminal. Accordingly, a user can safely receive the file via the network even if the user does not have an information apparatus having memory capacity large enough to receive the file.

### BACKGROUND OF THE INVENTION

1. Field of the Invention

The present invention relates to a file transfer system, a file management server, a file transfer method, and a program for causing a computer to perform the file transfer method, an image forming system, a stored document management server, and an image forming apparatus.

The present invention more particularly relates to a file transfer system, a file management server, a file transfer method, and a program for causing a computer to perform the file transfer method in which a computer file is uploaded from a file transmission apparatus to the file management server, and the uploaded file is downloaded from the file management server to a file reception apparatus.

The present invention further particularly relates to an image forming system in which a stored document is uploaded from a first image forming apparatus to a stored document management server, and the uploaded stored document is downloaded from the stored document management server to a second image forming apparatus, and to the stored document management server and an image forming apparatus used for the image forming system.

2. Description of the Related Art

Recently, various techniques using a printer connected to the Internet are proposed.

Japanese Laid-open Patent Application No. 2001-232904, for example, proposes a system that outputs digital information acquired from the Internet using a mobile communication terminal such as a cellular phone. A cellular phone user requests a Web server for information. The Web server acquires the requested information from an information server, and generates printer specific print control codes based on the acquired information. The Web server embeds the generated print control codes in an HTML file as the parameter of an applet, and transmits the HTML file to the cellular phone. The cellular phone runs the applet embedded in the received HTML file, and transfers the print control codes to a printer. The printer prints the requested information based on the transferred print control codes.

Japanese Laid-open Patent Application No. 2001-350603, for example, proposes a printing system with which a user, while out of his/her office, can easily print unformatted data using a format designated by the user. A printing terminal provided in the printing system downloads print data from a Web server via the Internet. The user selects a format in which the print data are printed, and sets up print processing.

Japanese Laid-open Patent Application No. 2001-256012, for example, proposes a print system in which a user can print application-dependent documents located in the network at a designated timing using a network printer by operating a web browser. The print system includes a client computer, a network printer, a file server computer, and a server computer connected to one another via a network. The server computer further includes a client service interface and a document print service. The client service interface transmits a print request form to the client computer so that the web browser of the client computer informs the server computer of the address of document data and designates a condition specifying timing to print the document data. The client service interface also interprets a print, request received from the client computer and issues a print instruction at the designated timing. In response to the print instruction, the document print service retrieves the document data from the file server computer via the Internet and/or the intranets, generates print data, and transmits the generated print data to the network printer via the Internet and/or the intranets.

Japanese Laid-open Patent Application No. 2001-265552, for example, proposes a digital information wide area print system. According to the invention, a user can print an HTML file or a VRML file stored in a WWW server using an Internet information receiving terminal disposed in convenience stores.

Japanese Laid-open Patent Application No. 2000-284919, for example, proposes a printer that can access the Internet alone and periodically print renewed web pages.

Additionally, according to the related art, it is possible to transfer documents stored in a user terminal such as a mobile phone and a PC or documents stored in a network server to a remove image forming apparatus such as a printer and a multi functional peripheral via a network, and to print the transferred documents. However, since the documents are transferred to the remote image forming apparatus via the network, the security of the documents matters.

Japanese Laid-open Patent Application No. 2002-32205, for example, proposes a network print system in which a user can print image data using a printer disposed in a print store without carrying the image data with him/her. According to the invention, the user transmits the image data from his/her PC to a print service server. The print service server assigns a document ID to the transmitted image data and stores the transmitted image data and the assigned document ID. The user is informed of the assigned document ID. When visiting the print store, the user inputs the document ID to the printer. The printer transmits the input document ID to the print service server via the network. The print service server, in response to reception of the document ID, transmits the stored image data to the printer. The printer prints the image data.

Japanese Laid-open Patent Application No. 10-235974, for example, proposes a network print system. According to the invention, image data is transmitted to a network server. The network server assigns a job number and a password to the image data and stores the transmitted image data and the assigned job number and password related each other. The network server transmits the assigned job number and password. When a user input the job number and password, a printer acquires the image data corresponding to the input job number and password from the net work server, and prints the acquired image data.

According to the related art described above, the security of files transmitted via a server is not considered at all. An employee of a company, for example, may directly transmit the file to a remote printer or a remote PC, if they are disposed in a branch office of the company, via the Internet. If the remote printer or the remote PC is disposed in a public place such as a convenience store, the file may be stolen by someone else. There is no guarantee that only a right receiver receives the file.

A mobile terminal such as a mobile phone and a personal data assistant (PDA) is not usually provided with a large memory capacity enough to receive a file. Even if a public printer is available, a user having nothing but the mobile terminal cannot print the file using the public printer.

### SUMMARY OF THE INVENTION

Accordingly, it is a general object of the present invention to provide a novel and useful file transfer system, a file management server, a file transfer method, and a program for causing a computer to perform the file transfer method, an image forming system, a stored document management server, and an image forming apparatus.

Another and more specific object of the present invention is to provide a file transfer system, a file management server, a file transfer method, and a program for causing a computer to perform the file transfer method in which a receiving user, even if he/she does not carry an information terminal having a memory capacity large enough to receive a file, can safely acquire the file from a transmitting user via the network.

Yet another and more specific object of the present invention is to provide an image forming system, a stored document management server, and an image forming apparatus used for the image forming system in which a user can print a stored document stored in a remote apparatus without directly operating the remote apparatus.

To achieve one or more of the above objects, a file transfer system according to an aspect of the present invention, includes: a file management server; a file transmitting terminal; and a file receiving terminal; wherein said file management server, said file transmitting terminal, and said file receiving terminal are connected each other via a network; said file transmitting terminal transmits to said file management server a file and a corresponding authorization condition for accessing said file; said file management server stores said file and said corresponding authorization condition transmitted from said file transmitting terminal; said file receiving terminal transmits to said file management server a request for transferring said file; and said file management server, in response to said request transmitted by said file receiving terminal, if said corresponding authorization condition stored therein is satisfied, transfers the file to said file receiving terminal.

The file transmitting terminal transmits the file and the authorization condition for accessing the file to the file management server. The file management server stores the file and the authorization condition for accessing the file transmitted by the file transmitting terminal related to the file. The file receiving terminal transmits a request for transmitting the stored file to the file management server. The file management server, in response to reception of the request for transmitting the stored file from the file receiving terminal, determines whether the request satisfies the stored authorization condition for accessing the file, and if the authorization condition is satisfied, transmits the file to the file receiving terminal.

According to another aspect of the present invention, a file management server connected to a file transmitting terminal and a file receiving terminal via a network, includes: a communication unit that exchanges data with an external apparatus via said network; a first storage unit that stores a file and an authorization condition for accessing said file related each other; and a file transferring unit that, in response to a request for transferring said file stored in said first storage unit from said file receiving terminal, if said authorization condition is satisfied, transfers said file to said file receiving terminal.

The communication unit exchanges data with an external apparatus via the network. The first storage unit stores the file and the authorization condition for accessing the file received from the file transmitting terminal, the authorization condition being related to the file. The file transferring unit, in response to reception of the request for transferring the file from the file receiving terminal, determines whether the request satisfies the authorization condition stored in the first storage unit, and if the request satisfies the authorization condition is satisfied, transmits the file to the file receiving terminal.

According to yet another aspect of the present invention, an image forming system, includes: a first image forming apparatus; a user terminal; and a second image forming apparatus; wherein said first image forming apparatus, said user terminal, and said second image forming apparatus are connected each other via a network; said first image forming apparatus stores a stored document and an authorization condition for accessing said stored document relating each other and, in response to a request from said user terminal, if said authorization condition is satisfied, transmits said stored document and said authorization condition to said second image forming apparatus; and said second image forming apparatus stores said stored document and said authorization condition relating each other and, if said authorization condition is satisfied, prints said stored document.

A user can acquire the stored document stored in the first image forming apparatus by giving an instruction for transmitting the stored document from the user terminal. The first image forming apparatus, in response to reception of the instruction, transmits the stored document and the authorization condition for accessing the stored document to the second image forming apparatus. The second image forming apparatus, in response to input of the authorization condition, prints the stored document corresponding to the authorization condition. Accordingly, the user can print the stored document stored in the first image forming apparatus that is disposed in a remote place using the second image forming apparatus. The stored document is protected by the authorization condition from an access by unauthorized person.

According to yet another aspect of the present invention, an image forming system includes: a first image forming apparatus; a stored document management server; a user terminal; and a second image forming apparatus; wherein said first image forming apparatus, said stored document management server, said user terminal, and said second image forming apparatus are connected each other via a network; said first image forming apparatus stores a stored document and an authorization condition for accessing said stored document relating each other and, in response to a request from said user terminal, if said authorization condition is satisfied, transmits said stored document and said authorization condition to said stored document management server; said stored document management server stores said stored document and said authorization condition transmitted from said first image forming apparatus relating each other and, in response to a request for transmitting said stored document from said second image forming apparatus, if said authorization condition for accessing said stored document is satisfied, transmits said stored document to said second image forming apparatus; and said second image forming apparatus prints said stored document transmitted from said stored document management server.

A user can acquire the stored document stored in the first image forming apparatus by giving an instruction for transmitting the stored document from the user terminal. The first image forming apparatus, in response to reception of the instruction, transmits the stored document and the authorization condition for accessing the stored document to the stored document management server. The stored document management server, in response to reception of the stored document and the authorization condition, transmits the authorization information for accessing the stored document to the user terminal. The second image forming apparatus, in response to input of the authorization condition, transmits the authorization condition to the stored document management server. The stored document management server, in response to reception of the authorization condition received from the second image forming apparatus, transmits the stored document to the second image forming apparatus. The second image forming apparatus prints the stored document received from the stored document management server transmits. Accordingly, the user can print the stored document stored in the first image forming apparatus that is disposed in a remote place using the stored document management server and the second image forming apparatus. The stored document remains protected by the authorization condition from an access by unauthorized person.

Other objects, features, and advantages of the present invention will become more apparent from the following detailed description when read in conjunction with the accompanying drawings.

### BRIEF DESCRIPTION OF THE DRAWINGS

FIG. 1 is a system diagram of a file transfer system according to a first embodiment;

FIG. 2 is a block diagram showing the structure of a file management server according to the first embodiment;

FIG. 3 is an example of a user management table stored in a personal information memory according to the first embodiment;

FIG. 4 is an example of data format stored in a file data memory according to the first embodiment;

FIG. 5 is a flow diagram for explaining file transfer of the file transfer system according to the first embodiment;

FIG. 6 is a flow diagram for explaining file transfer of the file transfer system according to the first embodiment;

FIG. 7 is a flow diagram for explaining file transfer of the file transfer system according to the first embodiment;

FIG. 8 shows the transition of web pages provided by the file management server according to the first embodiment;

FIG. 9 is an example of group management table stored in the personal information memory according to a second embodiment;

FIG. 10 is an example of data format stored in the file data memory according to the second embodiment;

FIG. 11 is a flow diagram for explaining file transfer of a file transfer system according to the second embodiment;

FIG. 12 is a flow diagram for explaining file transfer of a file transfer system according to the second embodiment;

FIG. 13 shows the transition of web pages provided by the file management server according to the second embodiment;

FIG. 14 is a flow diagram for explaining file transfer of a file transfer system according to a third embodiment;

FIG. 15 is a flow diagram for explaining file transfer of a file transfer system according to the third embodiment;

FIG. 16 shows the transition of web pages provided by the file management server according to the third embodiment;

FIG. 17 is a system diagram showing an image forming system according to a fourth embodiment;

FIG. 18 is a front view showing a multi functional peripheral A1 according to the fourth embodiment;

FIG. 19 is an enlarged cross section showing a printer 2100 according to the fourth embodiment;

FIG. 20 is a block diagram showing the structure of the multi functional peripheral A1 according to the fourth embodiment;

FIG. 21 is a block diagram showing the structure of an operations board 330 according to the fourth embodiment;

FIG. 22 is a schematic diagram showing the operations board 330 according to the fourth embodiment;

FIG. 23 is a flow diagram showing Internet transfer control of a system controller 31 of an image data processing apparatus ACP according to the fourth embodiment;

FIG. 24 is a flow showing print control of a system controller 31 according to the fourth embodiment;

FIG. 25 is a block diagram showing an image forming system according a fifth embodiment;

FIG. 26 is a flow diagram showing Internet transfer control of the system controller 31 of the image data processing apparatus ACP of the multi functional peripheral A1 according to the fifth embodiment;

FIG. 27 is a flow diagram showing transfer operation of a server D according to the fifth embodiment;

FIG. 28 is a flow diagram showing the print control of the system controller 31 of the image data processing apparatus ACP of the multi functional peripheral A1 according to the fifth embodiment; and

FIG. 29 is a flow diagram showing transfer operation of the server D according to a variation of the fifth embodiment.

### DETAILED DESCRIPTION OF THE PREFERRED EMBODIMENTS

Preferred embodiments of the present invention are described below with reference to the drawings.

[First Embodiment]

A file transfer system according to the first embodiment is described in detail below.

(Structure of the File Transfer System)

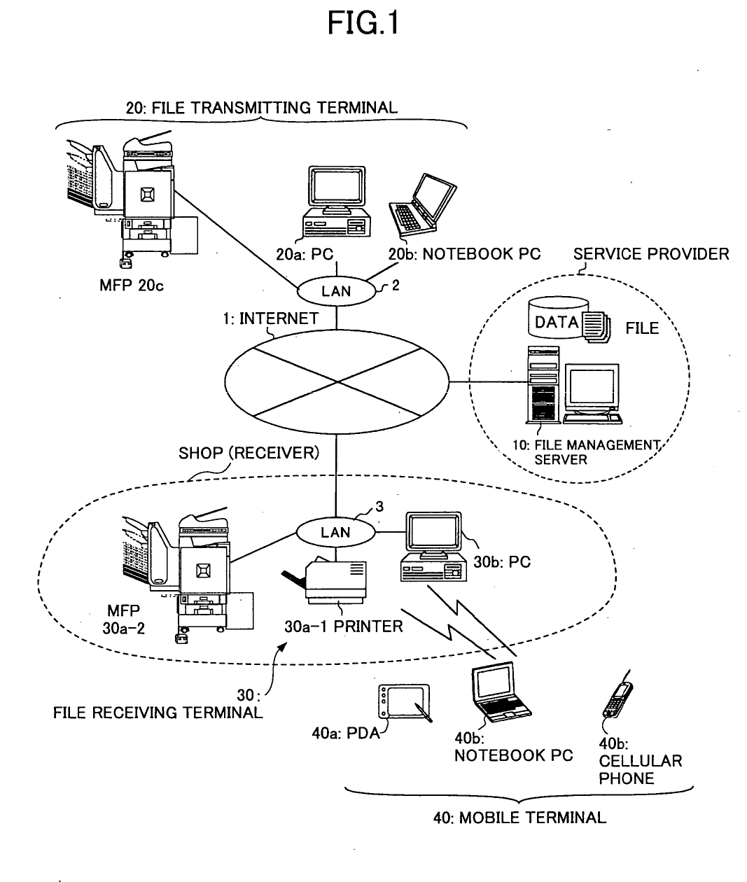

FIG. 1 is a system diagram showing the structure of a file transfer system according to the first embodiment. In FIG. 1, “1” denotes the Internet, “2” and “3” denote a Local Area Networks (LAN) connected to the Internet. A file management server 10 of a service provider is connected to the Internet 1. File transmitting terminals 20 such as a Personal Computer (PC) 20a, a notebook PC 20b, and a Multi Functional Peripheral (MFP) 20C are connected to the LAN 2. File receiving terminals such as a printer 30a-1, an MFP 30a-2, and a PC 30b are connected to the LAN 3. The LAN 3 is usually built in a shop such as a convenience store and a gas station. The file receiving terminals 30 are set up in the shop. “40” denotes a mobile terminals such as a Personal Data Assistant (PDA) 40a, a notebook PC 40b, and a cellular phone 40c of a user. The MFPs 20c, 30a-2 are described in detail below.

The file management server 10 can operate as a Web server. The file transmitting terminal 20, the tile receiving terminal 30, and the mobile terminal 40 are provided with a Web browser (a computer program). The user of the file transfer system can browse Web pages stored in the file management server 10.

The file management server 10 retains Web pages used for file transfer services. The file transmitting terminals 20 such as the PC 20a, the notebook PC 20b; and the MFP 20c uploads files by accessing the Web pages for file transfer service. The file receiving terminals 30 including image forming apparatuses 30a such as the printer 30a-1 and the MFP 30a-2, and the PC 30b downloads the files uploaded by the file transmitting terminals 20 by accessing the Web pages for file transfer service. The file transmitting terminal 20, the file receiving terminal 30, and the mobile terminal 40 are provided with network interface such as wire-less LAN and Bluetooth. The file receiving terminal 30 and the mobile terminal 40 communicates each other via the wireless LAN and/or the Bluetooth. The file receiving terminal 30 and the mobile terminal 40 access the file management server 10 via a LAN, or directly access the service provider through a telephone channel.

The file transfer operation of the above file transfer system is described below. The file transmitting terminal 20 uploads a file and an authorization condition (a password, for example) for accessing the file to the file management server 10. The file management server 10 relates and stores the file and the authorization condition for accessing the file. A transmitting user of the file transmitting terminal 20 informs the mobile terminal 40 of the receiving user about the name of the file and the authorization condition (password, for example) for accessing the file in advance using the file transmitting terminal 20, for example.

The receiving user, using the file receiving terminal 30, transmits a request for transmitting the file that designates the name of the file. If the request for transmitting the file satisfies an authorization condition of the file (a password set to the file, for example), the file management server 10, in response to the request for transmitting the file, permits access to the file thereby to transmit the file. In the case that the file receiving terminal 30 is an image forming apparatus, that is, the printer 30a-1 or the MFP 30a-2, the printer 30a-1 and/or the MFP 30a-2 print the received file. In the case that the file receiving terminal 30 is the PC 30b, the PC 30b stores the received file to a hard disk provided therein. In the case of the MFP 30a-2, the MFP 30a-2 may store the received file in a hard disk, and output (output formed image) afterwards.

[Structure of File Management Server]

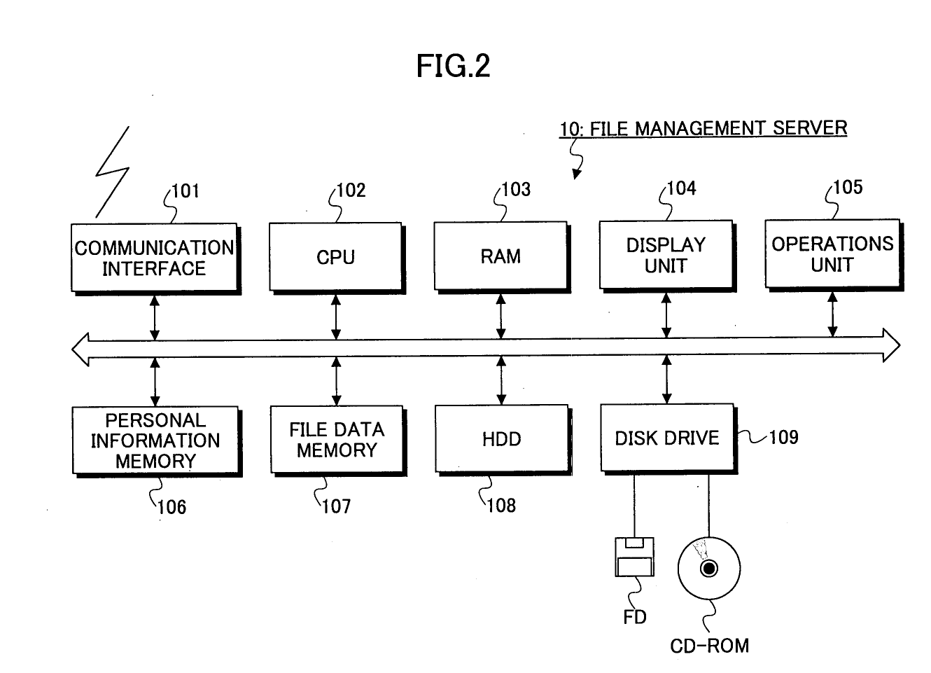

FIG. 2 is a block diagram showing the structure of the file management server 10 shown in FIG. 1. The file management server 10 is provided with the following: a communication interface 101, a CPU 102, a RAM 103, a display unit 104, a operations unit 105, a personal information memory 106, a file data memory 107, a hard disk drive 108, and a disk drive 109. Each unit is connected to each other via a bus.

The communication interface 101 is an interface for exchanging data with an external apparatus via the Internet 1. The CPU 102 controls each unit in accordance with programs stored in the hard disk (HDD) 108 or a flexible disk (FD) and/or a CD-ROM set at the disk drive 109. The communication interface 101, the RAM 103, the display unit 104, the operations unit 105, the personal information memory 106, the file data memory 107, the hard disk drive 108, and the disk drive 109 are connected to the CPU 101. The CPU 101 controls reading and writing of data, displaying, inputting from keyboard, and data communication. The display unit 104 includes a display apparatus such as an LCD and a CRT. The operations unit 105 is a user interface for a user to input data or instructions. The operations unit 105 may be a keyboard provided with a cursor key, numeric keys, and various functional keys, a mouse, and a scanner that reads images.

Various computer programs (OS, Web server program, for example) that are executed by the CPU 101 and data (Web pages, for example) are stored in the HDD 108. The CPU 101 executes the Web server program, and makes the Web pages stored in the HDD 108 public in the network. The CPU 101 further executes file transfer service that is to be described below. The Web pages are described in Hyper Text Markup Language (HTML) that Web application software can browse.

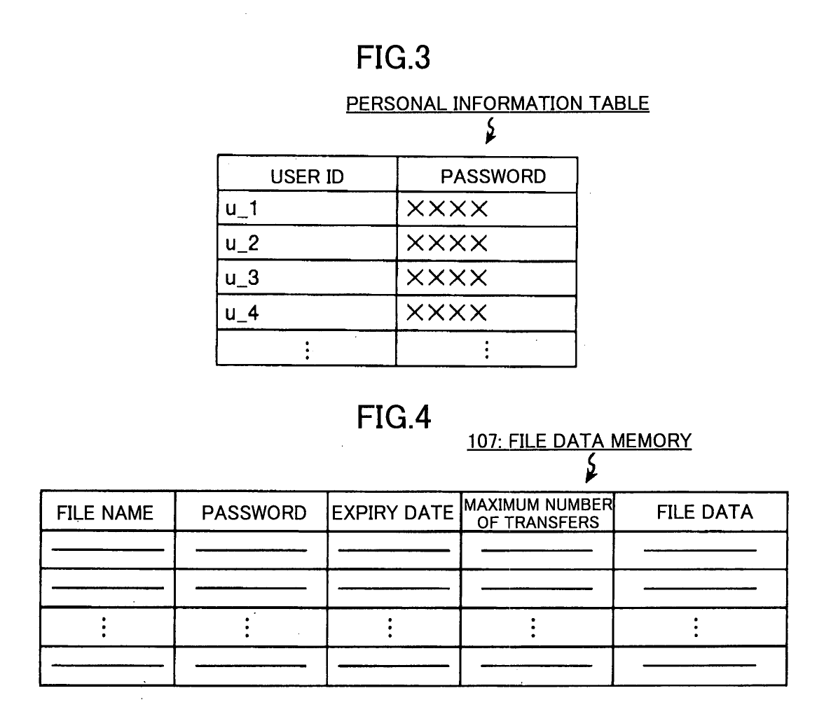

A user management table in which user IDs and passwords are registered for controlling users is stored in the personal information memory 106. FIG. 3 shows an example of the user management table. As shown in FIG. 3, the passwords are related to the respective user ID, and registered in the user management table.

The file data memory 107 stores file names, the passwords for accessing the files (file passwords), the expiry dates of the files, the maximum number of transfers of the files, and file data related to each other. FIG. 4 shows an example of the data format stored in the file data memory 107. The CPU 101 controls the data stored in the file data memory 107. The CPU 101 registers, searches, and/or deletes data, if necessary. When transmitting the file, the CPU 101 decrements the effective number T of transfers of the file by 1. If the effective number T of transfers of the file becomes “0”, or the effective period of the file has expired, the CPU 101 deletes the file (file name, password, expiry date, effective number T of transfers, and file data).

The disk drive 109 reads and writes data to a flexible disk (FD) and/or a CD-ROM.

[File Transfer Processing]

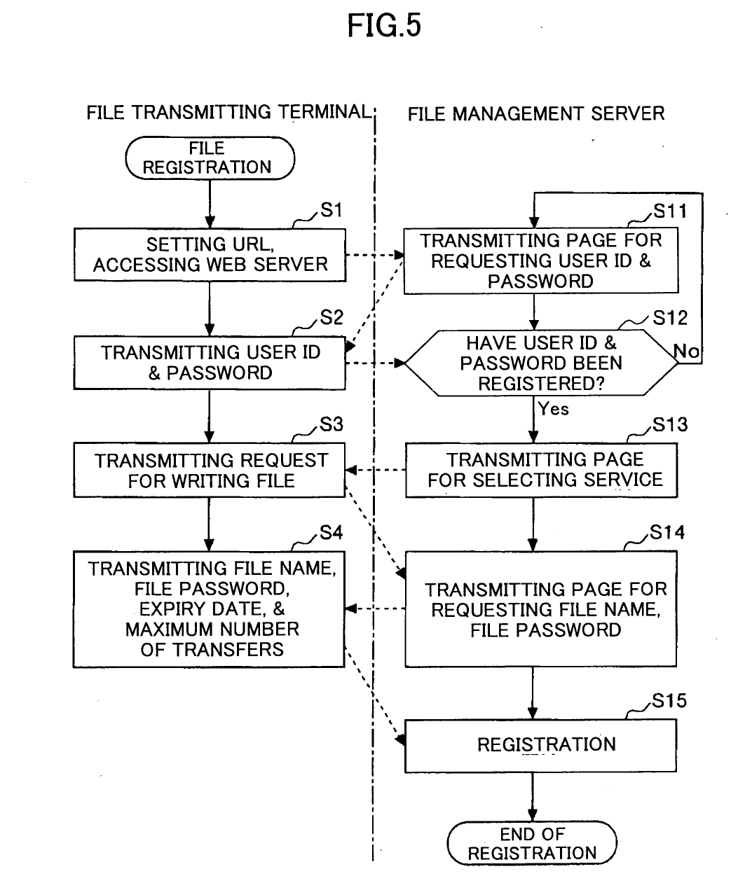

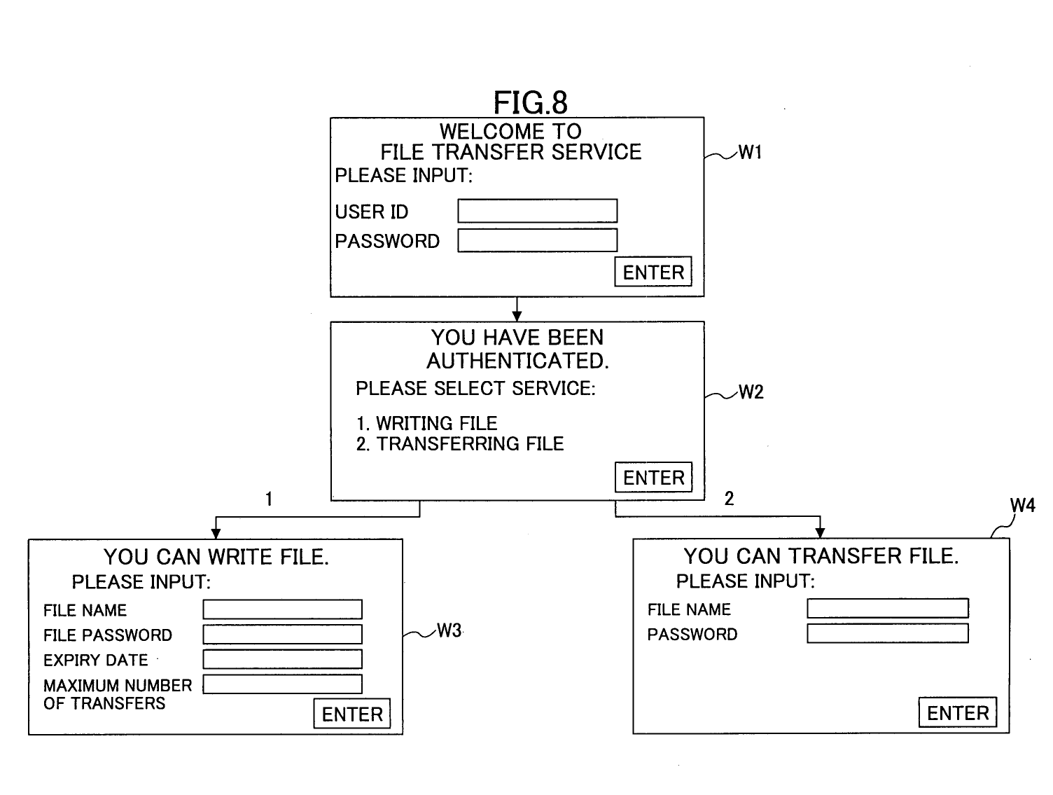

FIGS. 5-7 are flow charts for explaining file transfer processing of the file transfer system shown in FIG. 1. FIG. 8 shows an example of screens of Web pages provided by the file management server 10. In the following description, the case in which an image forming apparatus such as the printer 30a-1 or the MFP 30a-2 are used as the file receiving terminal 30.

File transfer processing of the file transfer system shown in FIG. 1 is described in accordance with the flow charts of FIGS. 5-7 and the screens of FIG. 8. First, processing for registering a file from the file transmitting terminal 20 of a transmitting user to the file management server 10. In FIG. 5, when a file needs to be transmitted to a remote receiving user, the transmitting user using the file transmitting apparatus 20 inputs URL of a Web page of the file management server 10 thereby to access the file management server 10 (step S1). The file management server 10, in response to the access from the file transmitting terminal 20, transmits a Web page W1 (first page) shown in FIG. 8 thereby to request the transmitting user to input his/her user ID and password (step S11). Input boxes for a user ID and a password and an enter button, for example, are provided in the Web page W1.

The file transmitting terminal 20, in response to receipt of the Web page W1, shows the received Web page W1 on the display unit. When the transmitting user inputs his/her user ID and password and presses the enter button, the input user ID and password are transmitted to the file management server 10 (step S2).

The file management server 10, in response to reception of the transmitted user ID and password from the file transmitting terminal 20, determines whether the received user ID and password are registered in the personal information table stored in the personal information memory 106 (step S12). If a negative determination is made (“No” in step S12), the process returns to step S11, and transmits the Web page W1 gain. If a positive determination is made (“Yes” in step S12), a Web page W2 for selecting a service is transmitted to the file transmitting terminal 20 (step S13). The Web page W2 includes two selection items, that is, “1. writing file” and “2. transferring file” and an enter button. The transmitting user who received the Web page W2 can select one of selection items.

The file transmitting terminal 20, in response to reception of the Web page W2, displays the Web page W2 on the display unit. When “1. writing file” is selected and the enter button is pressed, the file transmitting terminal 20 transmits a request for writing a file to the file management server 10 (step S3).

The file management server 10, in response to reception of the request for writing a file from the file transmitting terminal 20, transmits a web page W3 shown in FIG. 8 for setting a file name and an access right to the file to the file transmitting terminal 20 (step S14). The web page W3 includes input boxes for “file name” of a file, “password” corresponding to the file (file password), “expiry date” of the file, and “effective number of transfers” for which the file is transferable, and an enter button.

The file transmitting terminal 20, in response to reception of the web page W3, displays the web page W3 on the display unit. When the transmitting user inputs the “file name”, “password”, “expiry date”, and “effective number of transfers” into the respective input boxes, and presses the enter button, the file transmitting terminal 20 transmits the “file name”, “password”, “expiry date”, “effective number of transfers”, and the file data to the file management server 10 (step S4).

The file management server 10 relates the “file name”, “file password”, “expiry date”, “effective number of transfers” to each other, and stores them in the file data memory 107 (step S15). Then, uploading of a file is completed.

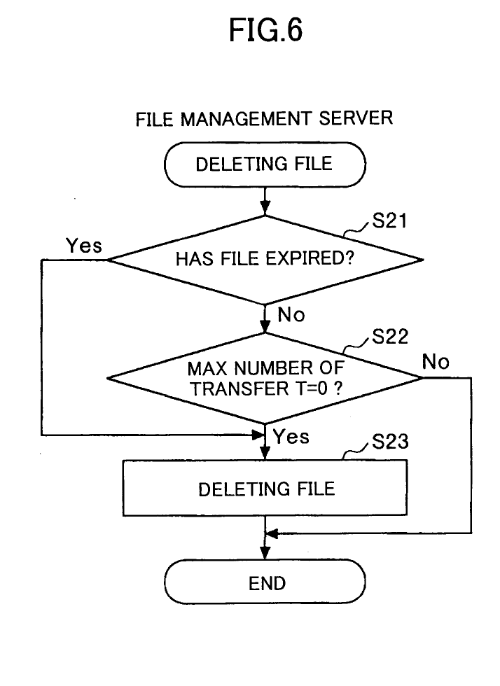

Deleting of data stored in the file data memory 107 of the file management server 10 is described below. FIG. 6 is a flow chart for explaining deleting of data stored in the file data memory 107 of the file management server 10. The file management server 10 periodically checks data stored in the file data memory 107. If the effective period of the file has been expired (step S21) or the effective number of transfers T=0 (step S22), the file management server 10 deletes the file (step S23).

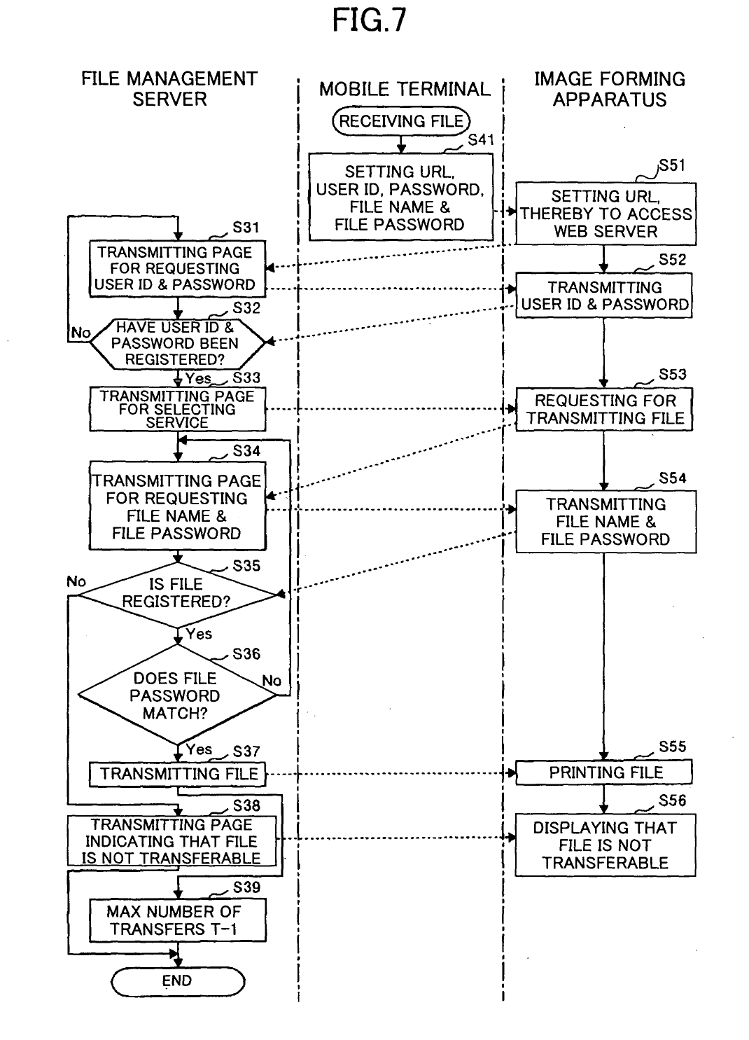

A process in which a receiving user accessed the file management server 10 and downloads a file is described below. In FIG. 7, the receiving user, using his/her mobile terminal 40, sets the following in the image forming apparatus 30a: the URL of the web page of the file management server 10, a user ID, a password, the file name of a file that the receiving user desires to print, and a password for accessing the file (file password) (step S41). The file receiving terminal 30 that downloads the file may be the PC 30b instead of the image forming apparatus 30a (the printer 30a-1 and the MFP 30a-2, for example).

When the URL of the web page of the file management server 10 is set, the image forming apparatus 30a accesses the file management server 10 (step S51). The file management server 10, in response to an access from the image forming apparatus 30a, the file management server 10 transmits the web page W1 (first page) shown in FIG. 8 for inputting a user ID and a password (step S31).

The image forming apparatus 30a, in response to reception of this web page W1, displays the web page W1 on the display unit. When the receiving user inputs his/her user ID and password in the web page W1 and presses the enter button, the user ID and the password are transmitted to the file management server 10 (step S52).

The file management server 10, in response to reception of the user ID and the password from the image forming apparatus 30a, determines whether the user ID and the password are registered in the personal information table stored in the personal information memory 106 (step S32). If a negative determination is made (No in step S32), the process returns to step S31, and transmits the web page W1 again. If a positive determination is made (Yes in step S32), the web page W2 shown in FIG. 8 for selecting a service item is transmitted to the image forming apparatus 30a (step S53).

The image forming apparatus 30a, in response to reception of the web page W2, displays the web page W2. When the receiving user selects “2. transferring file” in the web page W2 and presses the enter button, a request for transmitting a file is transmitted to the file management server 10 (step S53).

The file management server 10, in response to reception of the request for transmitting a file from the image forming apparatus 30a, transmits a web page W4 for designating a file shown in FIG. 8 to the image forming apparatus 30a (step S34). The web page W4 includes input boxes “file name” and “password” for accessing the file (file password), and an enter button.

The image forming apparatus 30a, in response to reception of the web page W4, displays the web page W4. When the receiving user inputs the “file name” and “password”, and presses the enter button, the “file name” and the “password” are transmitted to the file management server 10 (step S54).

The file management server 10, in response to reception of the “file name” and the “password”, determines whether there is a file corresponding to the received file name in the file data memory 107 (step S35). This step is needed because, as described above, if the effective period of the file has been expired or the effective number of transfers T=0, the file may have been deleted. If a negative determination is made (No in step S35), the process proceeds to step S38, and transmits a web page (not shown) for informing the receiving user that the file is not transferable to the image forming apparatus 30a (step S38).

The image forming apparatus 30a, in response to reception of the web page for informing the receiving user that the file is not transferable, displays the web page on the display unit (step S56). If a positive determination is made (Yes in step S35), the image forming apparatus 30a determines whether the received password for accessing the file (file password) is correct with reference to the file data memory 107 (step S36). If a negative determination is made, that is, the password is not correct (No in step S36), the process returns to step S34, and transmits the web page W4 to the image forming apparatus 30a again. If the password is correct (yes in step S36), the file management server transmits the file to the image forming apparatus 30a (step S37). Then, the file management server 10 decrements the effective number of transfers of the file by “1” (step S39). The image forming apparatus 30a, in response to reception of the file, outputs (prints) the file (step S55). The image forming apparatus 30a may temporarily store the received file in a hard disk provided therein and, after receiving a further instruction from the receiving user, output the file.

The case in which the file receiving terminal 30 is an image forming apparatus 30a such as the printer 30a-1 and the Multi Functional Peripheral (MFP) 30a-2 is described above. The case in which the receiving terminal 30 is the PC 30b is almost identical except that the received file is stored in a flexible disk FD, for example. Accordingly, the description of the latter case is omitted.

According to a first embodiment described above, a user of the file transmitting terminal 20 uploads a file and a password for accessing the file to the file management server 10. The file management server 10 stores the file and the password relating to each other. The file management server 10, in response to reception of a request for transmitting the file from the file receiving terminal 30, checks the password, and if the password is correct, transmits the designated file. A receiving user, even if he/she does not have a mobile apparatus having memory capacity large enough to receive the file, can receive the file using the file receiving terminal such as a printer, an MFP, and a PC disposed in a nearby shop, for example. If the file provider attaches a password to the file, the file management server does not transmit the file to anybody who does not know the password. Accordingly, the security of the file is improved.

Additionally, according to the first embodiment, the transmitting user of the file transmitting terminal 20 can designate an effective period of a file in which the file remains accessible, and the file management server 10 prohibits anyone from accessing the file once the effective period expires. Accordingly, the file transfer system can improve the security of the transmitted file.

Additionally, according to the first embodiment, the transmitting user of the file transmitting terminal 20 can designate the effective number of transfers of the file. Even if a plurality of users are authorized to access the file, the security of the file can be improved.

Additionally, according to the first embodiment, the file management server 10 decrements by 1 the effective number of transfers each time the file management server 10 transmits the file. When the effective number of transfers T=0 or the effective period of the file expires, the file management server 10 deletes data (the file name, the password, the expiry date, the effective number T of transfers) as well as the file, memory resources can be used efficiently.

The file management server 10 may automatically delete the file after transmitting the file once. In this case, the file transmitting terminal 10 does not need to designate the expiry date and the effective number of transfers. Accordingly, the security of the file can be improved and the memory resource can be used efficiently.

[Second Embodiment]

A file transfer system according to a second embodiment is described with reference to the above FIGS. 1, 2, and FIGS. 9-13. When uploading a file to the file management server 10, the file transmitting terminal 20 designates a group name as a condition for accessing the file. Only users whose user ID belongs to the group can access the file.

The structure of the file transfer system according to the second embodiment is identical to that of the first embodiment (see FIG. 1). The structure of the file management server 10 is almost identical to that of the file management server according to the first embodiment (see FIG. 2), but is different in that the file management server 10 according to the second embodiment stores a group registration table in which group names and corresponding user IDs in the personal information memory 106.

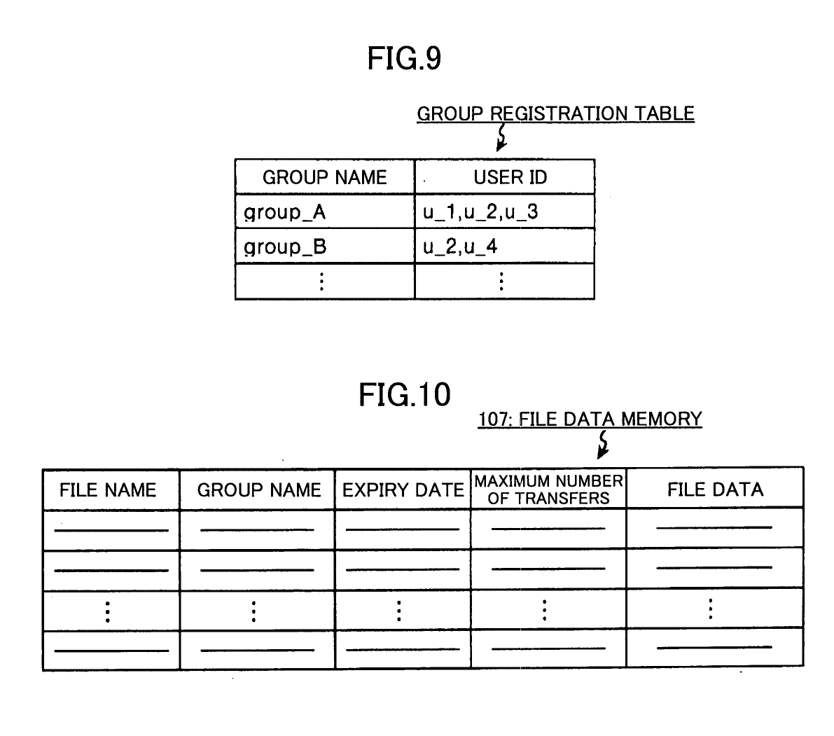

FIG. 9 shows an example of the group registration table. As shown in FIG. 9, two groups A and B are registered in the group registration table. Members whose user IDs are u_1, U_2, and u_3 belong to the group A, and members whose user IDs are u_2 and u_4 belong to the group B. The group includes a company or a school, for example. When uploading a file to the file management server 10, the file transmitting terminal 20 designates a group that can access the file. Only a receiving user of the file receiving terminal 30 who inputs a user ID who belongs to the designated group can access the file. In the case that the group B is designated, only the users u_2 and u_4 can access the file.

FIG. 10 shows an example of the format of data stored in the file data memory 107. The data format shown in FIG. 10 is different from the data format according to the first embodiment in that the group name is registered instead of the password. As shown in FIG. 10, the file name, the group name that is authorized to access the file, the expiry date of the file, and the effective number T of transfers of the file, and the file data relating to each other, input by the file transmitting terminal 20 of the transmitting user are stored in the file data memory 107.

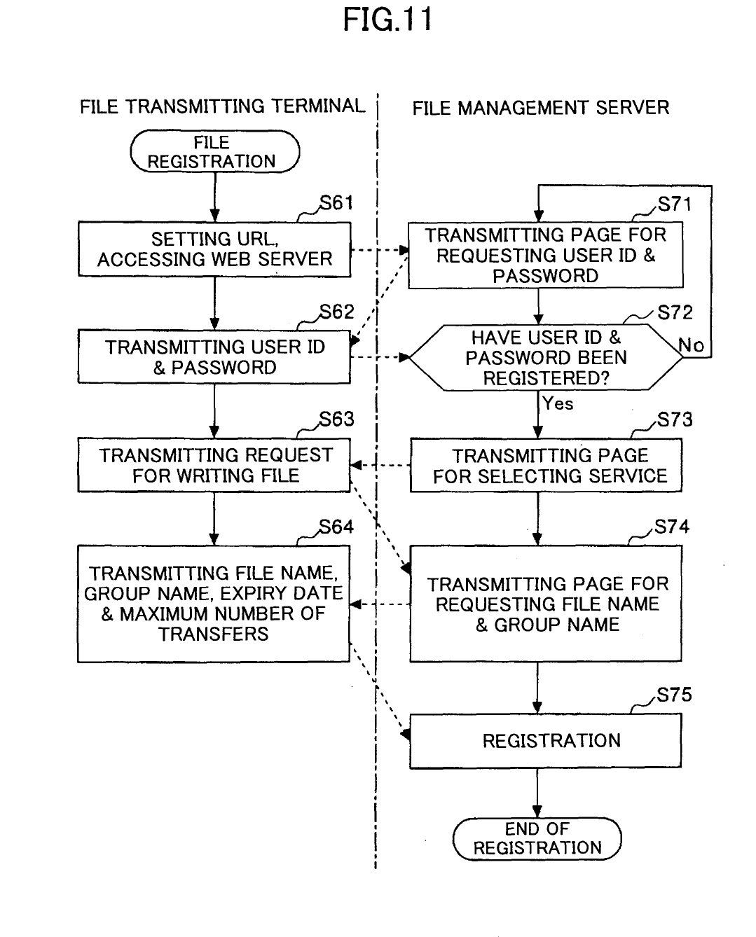

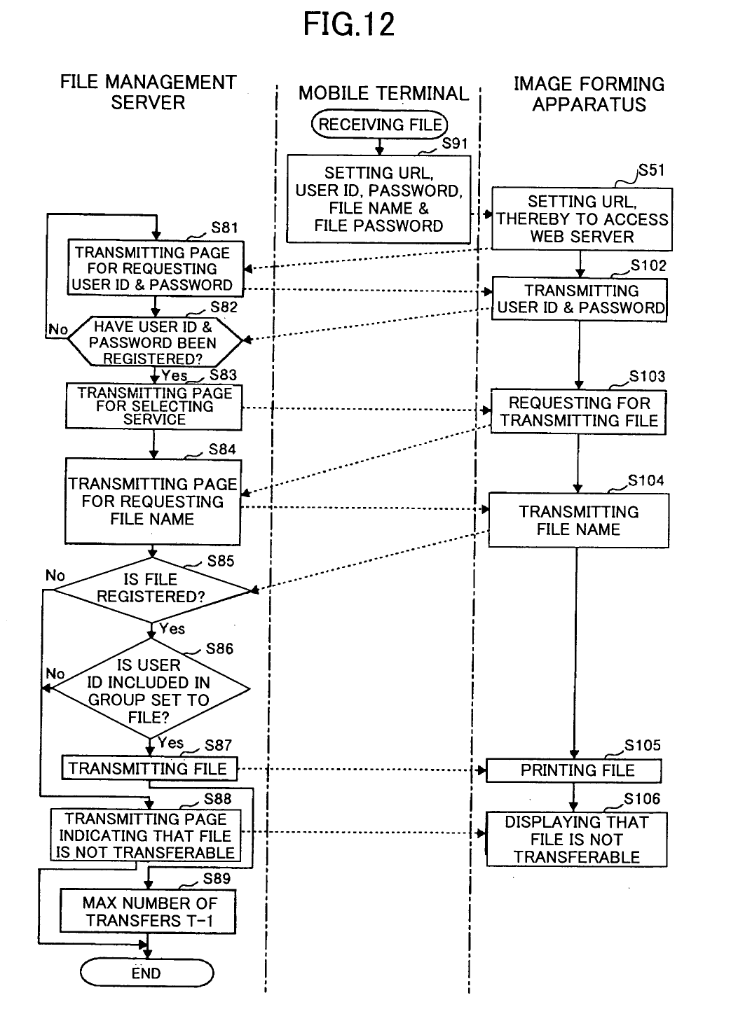

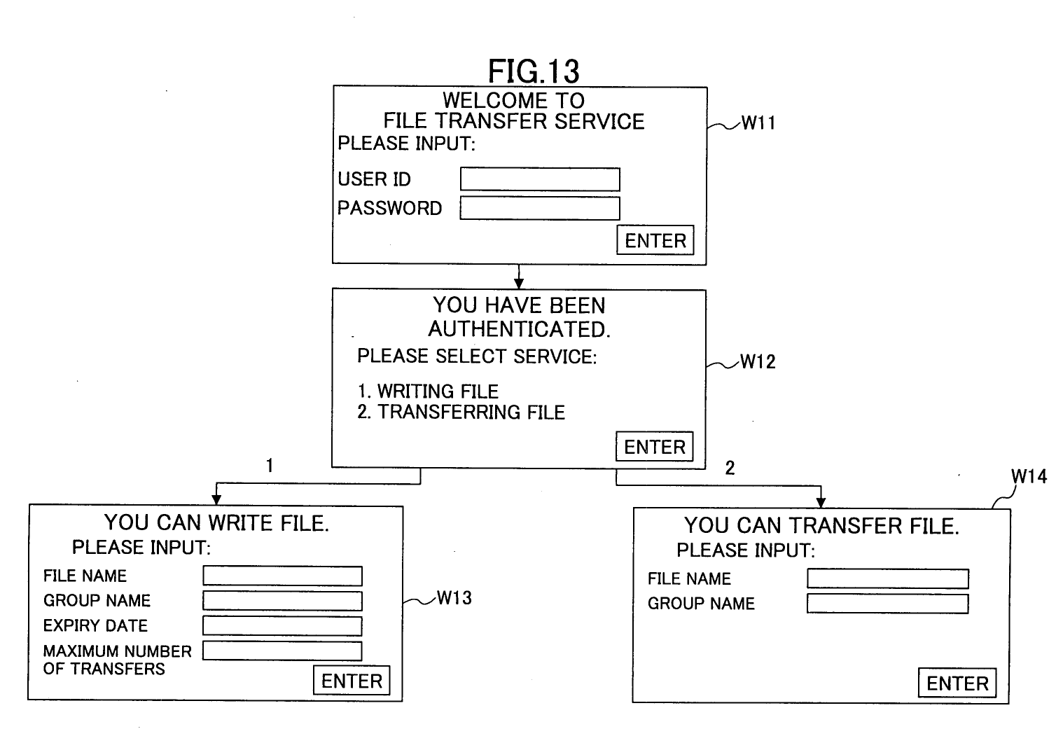

FIGS. 11 and 12 are flow charts for explaining the file transfer system according to the second embodiment. FIG. 13 shows the transition of web pages provided by the file management server 10. In the following description, the file receiving terminal 30 is assumed to be an image forming apparatus 30a such as the printer 30a-l and the MFP 30a-2.

File transfer processing of the file transfer system shown in FIG. 1 is described in accordance with the flow charts of FIGS. 11 and 12, and the exemplary web pages shown in FIG. 13. First, processing for registering a file from the file transmitting terminal 20 of a transmitting user to the file management server 10. In FIG. 11, when a file needs to be transmitted to a remote receiving user, a transmitting user using the file transmitting apparatus 20 inputs URL of a Web page of the file management server 10 thereby to access the file management server 10 (step S61). The file management server 10, in response to the access from the file transmitting terminal 20, transmits a Web page W1 (first page) shown in FIG. 13 thereby to request the transmitting user to input his/her user ID and password (step S71). Input boxes for a user ID and a password and an enter button, for example, are provided in the Web page W1.

The file transmitting terminal 20, in response to receipt of the Web page W11, shows the received Web page W1 on the display unit. When the transmitting user inputs his/her user ID and password and presses the enter button, the input user ID and password are transmitted to the file management server 10 (step S62).

The file management server 10, in response to reception of the transmitted user ID and password from the file transmitting terminal 20, determines whether the received user ID and password are registered in the personal information table stored in the personal information memory 106 (step S72). If a negative determination is made (“No” in step S72), the process returns to step S71, and transmits the Web page W11 again. If a positive determination is made (“Yes” in step S72), a Web page W12 for selecting a service is transmitted to the file transmitting terminal 20 (step S73). The Web page W12 includes two selection items, that is, “1. writing file” and “2. transferring file”, and an enter button. The transmitting user who received the Web page W12 can select one of the selection items.

The file transmitting terminal 20, in response to reception of the Web page W12, displays the Web page W12 on the display unit. When “1. writing file” is selected and the enter button is pressed, the file transmitting terminal 20 transmits a request for writing a file to the file management server 10 (step S63).

The file management server 10, in response to reception of the request for writing a file from the file transmitting terminal 20, transmits a web page W13 shown in FIG. 13 for setting a file name and an access right to the file, to the file transmitting terminal 20 (step S74). The web page W13 includes input boxes for “file name” of a file, “group name” that is authorized to access the file, “expiry date” of the file, and “effective number of transfers” for which the file is transferable, and an enter button.

The file transmitting terminal 20, in response to reception of the web page W13, displays the web page W13 on the display unit. When the transmitting user inputs the “file name”, “group name”, “expiry date”, and “effective number of transfers” into the respective input boxes, and presses the enter button, the file transmitting terminal 20 transmits the “file name”, “group name”, “expiry date”, “effective number of transfers”, and the file data to the file management server 10 (step S64).

The file management server 10 relates the “file name”, “group name”, “expiry date”, “effective number of transfers” to each other, and stores them in the file data memory 107 (step S75). Then, uploading of a file is completed.

The file management server 10 checks files stored in the file data memory 107 and deletes the files of which effective period has expired or the effective number of transfers T=0 in the same manner as the first embodiment (see FIG. 6).

Processing in which a receiving user accessed the file management server 10 and downloads a file is described below. In FIG. 12, the receiving user, using his/her mobile terminal 40, sets the following in the image forming apparatus 30a: the URL of the web page of the file management server 10, a user ID, a password, the file name of a file that the receiving user desires to print, and a password for accessing the file (file password) (step S91). The file receiving terminal 30 that downloads the file may be the PC 30b instead of the image forming apparatus 30a (the printer 30a-1 and the MFP 30a-2, for example).

When the URL of the web page of the file management server 10 is set, the image forming apparatus 30a accesses the file management server 10 (step S101). The file management server 10, in response to an access from the image forming apparatus 30a, transmits the web page W11 (first page) shown in FIG. 13 for inputting a user ID and a password (step S81).

The image forming apparatus 30a, in response to reception of this web page W11, displays the web page W11 on the display unit. When the receiving user inputs his/her user ID and password in the web page W11 and presses the enter button, the user ID and the password are transmitted to the file management server 10 (step S102).

The file management server 10, in response to reception of the user ID and the password from the image forming apparatus 30a, determines whether the user ID and the password are registered in the personal information table stored in the personal information memory 106 (step S82). If a negative determination is made (No in step S82), the process returns to step S81, and transmits the web page W1 again. If a positive determination is made (Yes in step S82), the web page W12 for selecting a service item, shown in FIG. 13, is transmitted to the image forming apparatus 30a (step S83).

The image forming apparatus 30a, in response to reception of the web page W12, displays the web page W12 on the display unit. When the receiving user selects “2. transferring file” in the web page W12 and presses the enter button, a request for transmitting a file is transmitted to the file management server 10 (step S103).

The file management server 10, in response to reception of the request for transmitting a file from the image forming apparatus 30a, transmits a web page W14 for designating a file shown in FIG. 13 to the image forming apparatus 30a (step S84). The web page W14 includes input boxes “file name” and an enter button.

The image forming apparatus 30a, in response to reception of the web page W14, displays the web page W14. When the receiving user inputs the “file name” that he/she desires to print, and presses the enter button, the “file name” is transmitted to the file management server 10 (step S104).

The file management server 10, in response to reception of the “file name”, determines whether there is a file corresponding to the received file name in the file data memory 107 (step S85). This step is needed because, as described above, if the effective period of the file has been expired or the effective number of transfers T=0, the file may have been deleted.

If a negative determination is made (No in step S85), the process proceeds to step S88, and transmits a web page (not shown) for informing the receiving user that the file is not transferable to the image forming apparatus 30a (step S88). If there is the designated file (Yes in step S85), the file management server 10 verifies the group name designated to the designated file by referring to the file data memory 107 (see FIG. 9). The file management server 10 further determines whether the received user ID belongs to the group by referring to the group registration table (see FIG. 10) (step S86). If the received user ID does not belong to the designated group (No in step S86), the process proceeds to step S88. In step S88, the file management server 10 transmits a web page (not shown) for informing the receiving user that the file is not transferable to the image forming apparatus 30a. The image forming apparatus 30a, in response to reception of the web page for informing the receiving user that the file is not transferable, displays the web page on the display unit (step S106).

If a positive determination is made, that is, the received user ID belongs to the designated group (Yes in step S86), the file management server 10 transmits the designated file to the image forming apparatus 30a (step S87). Then, the file management server 10 decrements the effective number of transfers of the file, stored in the file data memory 107, by “1” (step S89). The image forming apparatus 30a, in response to reception of the file, outputs (prints) the file (step S105). The image forming apparatus 30a may temporarily store the received file in a hard disk provided therein and, after receiving a further instruction from the receiving user, output the file.

The case in which the file receiving terminal 30 is an image forming apparatus 30a such as the printer 30a-1 and the Multi Functional Peripheral (MFP) 30a-2 is described above. The case in which the receiving terminal 30 is the PC 30b is almost identical except that the received file is stored in a flexible disk FD, for example. Accordingly, the description of the latter case is omitted.

According to the second embodiment described above, the file management server 10 stores relating the group name and the user IDs of group members. When uploading a file, the file transmitting terminal 20 transmits the file and a group name that is authorized to access the file, to the file management server 10. The file management server 10 stores relating the uploaded file with the group name. The file management server 10, in response to reception of a request for transmitting the file from the file receiving terminal 30, determines whether the user ID received from the file receiving terminal 30 belongs to the group designated to the file. Only if the received user ID belongs to the designated group, the file management server 10 transmits the file to the file receiving terminal 30. Accordingly, in the file transfer system according to the second embodiment, only group members can access the file stored in the file management server 10, and anyone who does not belong to the group is prohibited from accessing the file stored in the file management server 10. Whereas a receiving user using the file transfer system according to the first embodiment is required to input a password, a receiving user who is a group member, using the file transfer system according to the second embodiment can access the file without inputting passwords.

According to the second embodiment described above, when a file is uploaded to the file management server 10, a group that is authorized to access the file is designated. Instead of designating a group, one or more users who are authorized to access the file may be designated. In this case, only the designated users can download the file from the file management server 10, and any user who is not designated cannot access the file.

[Third Embodiment]

A file transfer system according to a third embodiment is described with reference to the above FIGS. 1, 2, and FIGS. 14-16. According to the third embodiment, a user of a mobile terminal 40 obtains the IP address of the file receiving terminal 30 and informs the file management server 10 of the obtained IP address. The file management server 10 registers the informed IP address, and accepts a request for transmitting a file from only file receiving terminal 30 of which IP address is registered.

The structure of the file transfer system according to the third embodiment is identical to that of the first embodiment (see FIG. 1). The structure of the file management server 10 is almost identical to that of the file management server according to the first embodiment (see FIG. 2), but is different in that the file management server 10 according to the third embodiment stores file names and IP addresses of file receiving terminals that are permitted to access the file, in the personal information memory 106.

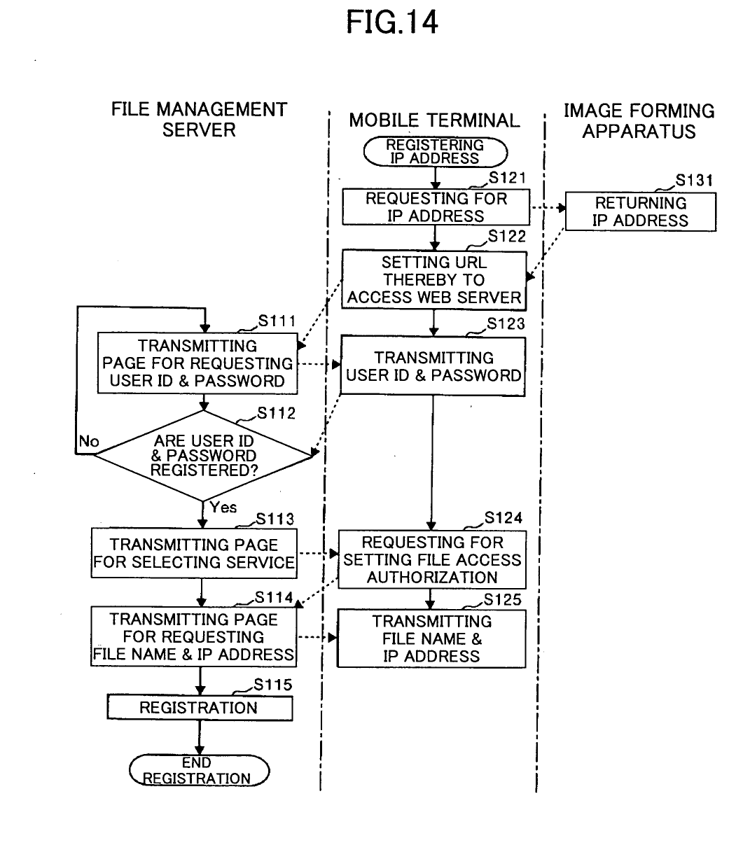

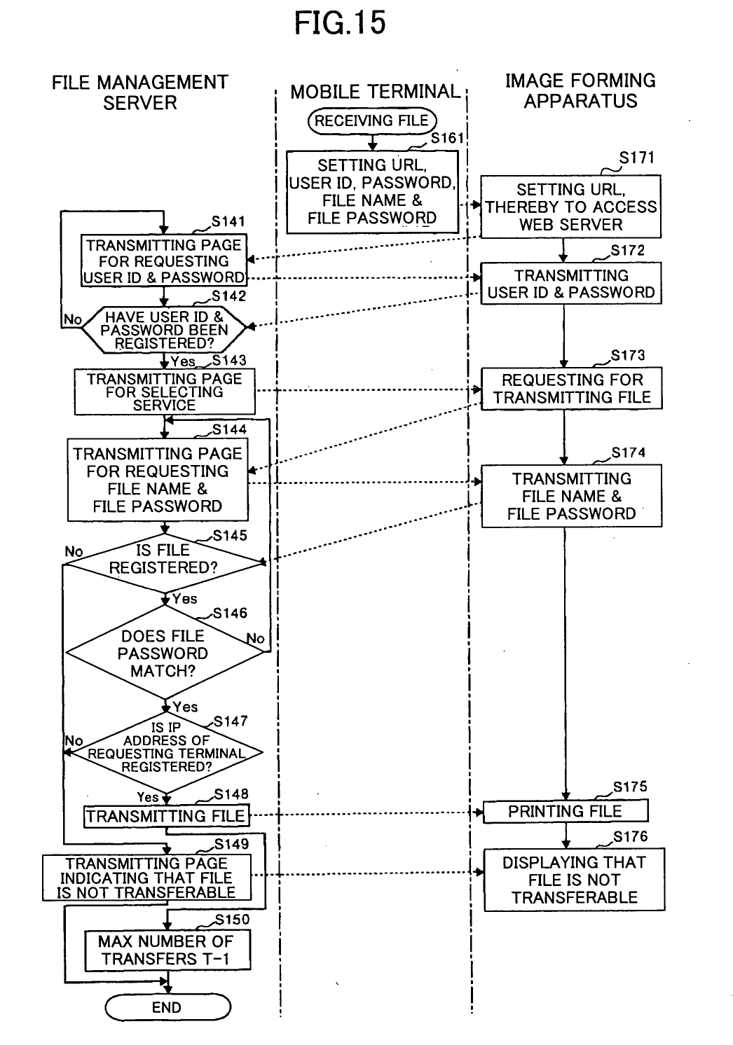

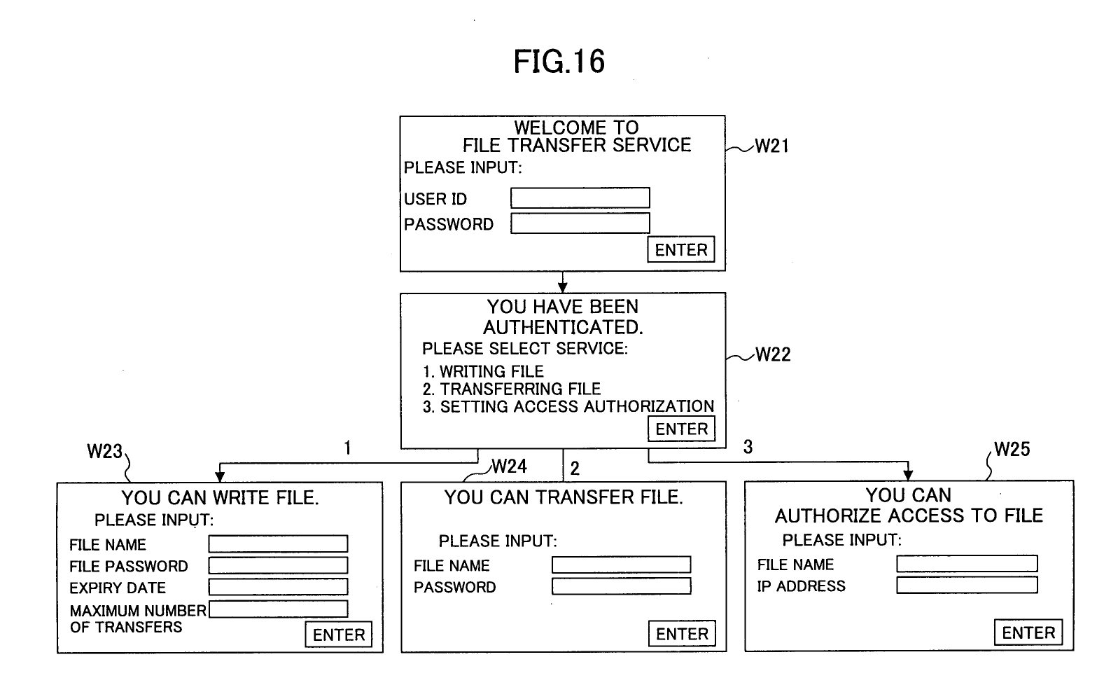

File transfer processing of the file transfer system according to the third embodiment is described in accordance with the flow charts of FIGS. 14 and 15, and the exemplary web pages shown in FIG. 16. Processing for uploading a file from the file transmitting terminal 20 to the file management server 10 is the same as that of the first embodiment described with reference to FIG. 5. The file management server 10 periodically checks files stored in the file data memory 107, and deletes files of which effective period have expired or effective number of transfers T=0 in the same manner as the file management server 10 according to the first embodiment.

Processing for registering the IP address of a file receiving terminal 30 that is authorized to access the file is described below. In FIG. 14, the receiving user, using the mobile terminal 40, requests the image forming apparatus 30a such as the printer 30a-1 and the Multi Functional Peripheral 30a-2, to transmit its IP address (step S121). The image forming apparatus 30a, in response to reception of the request for the IP address, transmits its IP address to the mobile terminal 40 (step S131).

A transmitting user using the file transmitting apparatus 20 inputs URL of a Web page of the file management server 10 thereby to access the file management server 10 (step S122). The file management server 10, in response to the access from the file transmitting terminal 20, transmits a Web page W21 (first page) shown in FIG. 16 thereby to request the transmitting user to input his/her user ID and password (step Sill). Input boxes for a user ID and a password and an enter button, for example, are provided in the Web page W21.

The file transmitting terminal 20, in response to receipt of the Web page W21, shows the received Web page W21 on the display unit. When the transmitting user inputs his/her user ID and password and presses the enter button, the input user ID and password are transmitted to the file management server 10 (step S123).

The file management server 10, in response to reception of the transmitted user ID and password from the mobile terminal 40, determines whether the received user ID and password are registered in the personal information table stored in the personal information memory 106 (step S112). If a negative determination is made (“No” in step S112), the process returns to step S111, and transmits the Web page W21 again. If a positive determination is made (“Yes” in step S112), a Web page W22 for selecting a service is transmitted to the mobile terminal 40 (step S113). The Web page W22 includes two selection items, that is, “1. writing file”, “2. transferring file”, and “3. setting access permission”, and an enter button. The transmitting user who received the Web page W22 can select one of the selection items.

The mobile terminal 40, in response to reception of the Web page W22, displays the Web page W22. When “3. setting access permission” is selected and the enter button is pressed, the a request for setting an access permission is transmitted to the file management server 10 (step S124).

The file management server 10, in response to reception of the request for setting an access permission from the mobile terminal 40, transmits a web page W23 shown in FIG. 16 for inputting a file name and setting an access right to the file, to the mobile terminal 40 (step S114). The web page W23 includes input boxes for “file name” and the “IP address” from which an access is authorized, and an enter button.

The mobile terminal 40, in response to reception of the web page W23, displays the web page W23 on a display unit. When the transmitting user inputs the “file name” and “IP address” into the respective input boxes, and presses the enter button, the mobile terminal 40 transmits the “file name” and the “IP address” to the file management server 10 (step S125).

The file management server 10 relates the “file name” and the “IP address” to each other, and stores them in the personal information memory 106 (step S115). The registration of IP address then ends.

Processing in which a receiving user accessed the file management server 10 and downloads a file is described below. In FIG. 15, the receiving user, using his/her mobile terminal 40, sets the following in the image forming apparatus 30a: the URL of the web page of the file management server 10, a user ID, a password, the file name of a file that the receiving user desires to print, and a password for accessing the file (file password) (step S161).

When the URL of the web page of the file management server 10 is set, the image forming apparatus 30a accesses the file management server 10 (step S171). The file management server 10, in response to an access from the image forming apparatus 30a, transmits the web page W21 (first page) shown in FIG. 16 for inputting a user ID and a password (step S141).

The image forming apparatus 30a, in response to reception of this web page W21, displays the web page W21 on the display unit. When the receiving user inputs his/her user ID and password in the web page W21 and presses the enter button, the user ID and the password are transmitted to the file management server 10 (step S172).

The file management server 10, in response to reception of the user ID and the password from the image forming apparatus 30a, determines whether the user ID and the password are registered in the personal information table stored in the personal information memory 106 (step S142). If a negative determination is made (No in step S142), the process returns to step S141, and transmits the web page W21 again. If a positive determination is made (Yes in step S142), the web page W22 for selecting a service item, shown in FIG. 16, is transmitted to the image forming apparatus 30a (step S143).

The image forming apparatus 30a, in response to reception of the web page W22, displays the web page W22 on the display unit. When the receiving user selects “2. transferring file” in the web page W22 and presses the enter button, a request for transmitting a file is transmitted to the file management server 10 (step S173).

The file management server 10, in response to reception of the request for transmitting a file from the image forming apparatus 30a, transmits a web page W24 for designating a file shown in FIG. 16 to the image forming apparatus 30a (step S144). The web page W24 includes input boxes “file name” and “password”, and an enter button.

The image forming apparatus 30a, in response to reception of the web page W24, displays the web page W24 on the display unit. When the receiving user inputs the “file name” that he/she desires to print and the “password” for accessing the file, and presses the enter button, the “file name” and the “password” are transmitted to the file management server 10 (step S174).

The file management server 10, in response to reception of the “file name” and the “password” from the image forming apparatus 30a, determines whether there is a file corresponding to the received file name in the file data memory 107 (step S145). This step is needed because, as described above, if the effective period of the file has been expired or the effective number of transfers T=0, the file may have been deleted. If a negative determination is made (No in step S145), the process proceeds to step S149, and transmits a web page (not shown) for informing the receiving user that the file is not transferable to the image forming apparatus 30a (step S149). The image forming apparatus 30a, in response to reception of the web page informing that the file is not transferable, displays the received web page on the display unit (step S176).

If there is the designated file (Yes in step S145), the file management server 10 verifies the password for accessing the file by referring to the file data memory 107 (step S146). If the password is not correct (No in step S146), the process returns to step S144, and transmits the web page W24 to the image forming apparatus 30a again. If the password is correct (yes in step S136), the file management server 10 determines whether the IP address of the image forming apparatus 30a matches the IP address registered in the personal information memory 106 (step S147). If the IP addresses do not match (no in step S147), the process proceeds to step s149. The file management server 10 transmits a web page for informing the receiving user that the file is not transferable (not shown) to the image forming apparatus 30a (step s149).

If the IP address of the image forming apparatus 30a matches the IP address registered in the personal information memory 106 (yes in step s147), the file management server 10 reads the designated file from the file data memory 106 and transmits the file to the image forming apparatus 30a (step S148). The process proceeds to step s150, and decrements the effective number of transfers T stored in the file data memory 107 by “1”. The image forming apparatus 30a, in response to reception of the file, prints the file (step S175).

The case in which the file receiving terminal 30 is an image forming apparatus 30a such as the printer 30a-1 and the Multi Functional Peripheral (MFP) 30a-2 is described above. The case in which the receiving terminal 30 is the PC 30b is almost identical except that the received file is stored in a flexible disk FD, for example. Accordingly, the description of the latter case is omitted.

According to the third embodiment described above, the user of the mobile terminal 40 obtains the IP address of the file receiving terminal 30 and informs the IP address to the file management server 10. The file management server 10 accepts a request for transmitting the file only if the request is from the designated IP address. Accordingly, the file management server 10 can identify the file receiving terminal that is authorized to receive the file, and only authorized file receiving terminal can access the file.

In the file transfer system according to the third embodiment described above, a password for accessing the file is uploaded from the file transmitting terminal 20 to the file management server 10 in the same manner as the first embodiment. However, a user group may that is authorized to access the file may be designated and transmitted to the file management server 10 in the same manner as the second embodiment.

[Fourth Embodiment]

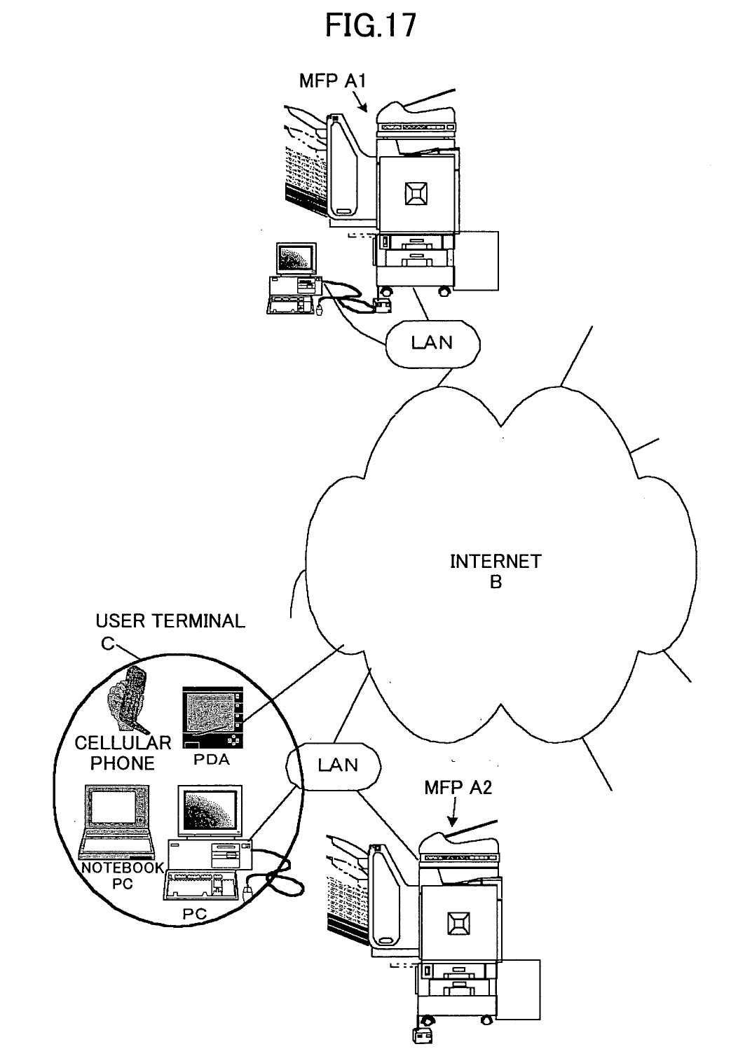

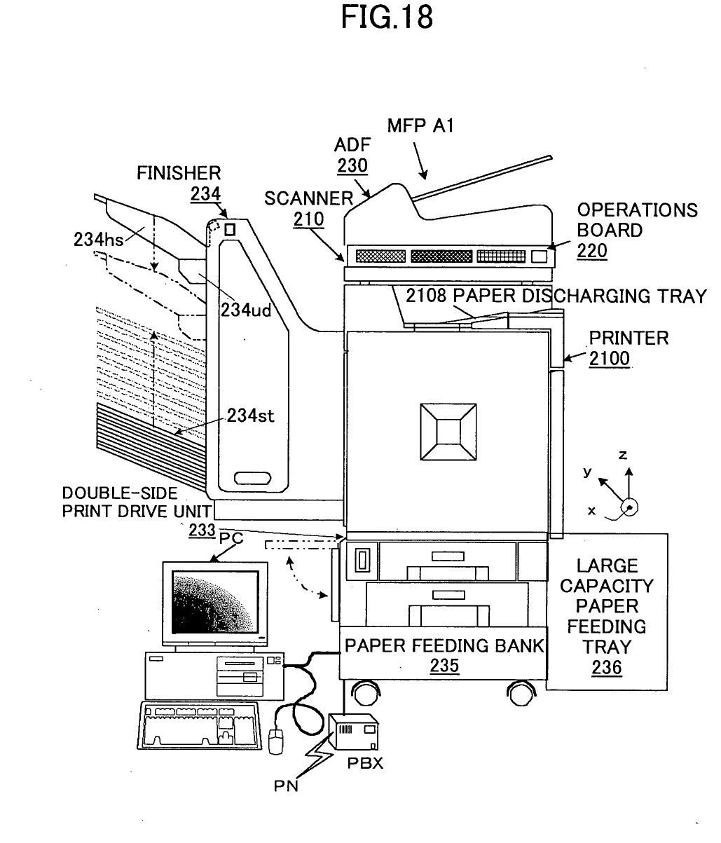

FIG. 17 is an image forming system according to a fourth embodiment of the present invention. A Multi Functional Peripherals (MFP) A1 and A2, that is, image forming apparatuses, may be multi functional color copiers having the same specifications, for example. The MFP A1 and A2 can communicates each other via a local area network (LAN) and/or the Internet B. The MFP A1 and A2 also can communicates with a personal computer PC, a notebook PC, a personal data assistant (PDA), and a mobile phone, for example. The MFP A1 and A2 may not have the same specifications.

According to an embodiment, the MFP A1 stores documents (stored documents) such as image data acquired by a scanner and a digital camera, image data created by computer graphics and CAD, document data created by a word processor, and facsimile data. When a user needs to access a stored document but is far from the MFP A1, the user accesses the MFP A1 using a user terminal C via the Internet B, and request the MFP A1 to transmit the stored document to the MFP A2 near the user. The MFP A2, in response to the request, transmits the designated stored document with a password to access the stored document, to the designated MFP A2 via the Internet B. When the user inputs the password to the MFP A2, the MFP A2 prints the stored document.

According to another embodiment, the user operates an operations board of the MFP A1 (image forming apparatus) that stores the stored document thereby to transmit the stored document to the MFP A2 (image forming apparatus) located at a place where the user is planning to visit. The MFP A1, in response to the operation, transmits the designated stored document and the password for outputting the stored document to the designated MFP A2. When the user visits the place and inputs the password to the MFP A2, the MFP A2 outputs (print) the stored document.

FIG. 18 is a front view showing a multi functional full color digital copier (MFP) A1 shown in FIG. 17, as an embodiment of an image forming apparatus. The structure and functions of the MFP A2 is the same as those of the MFP A1. This multi functional full color digital copier is an example of the MFP according to the first through third embodiments described above.

The full color copier shown in FIG. 18 is configured by an automatic document feeder (ADF) 230, an operations board 220, a color scanner 210, a color printer 2100, and a paper feeding bank 235. A finisher 234 having trays in which stapled and/or printed pieces of paper is placed, a double-side print drive unit 233, and a large capacity paper feeding tray 236 are mounted on the printer 2100.

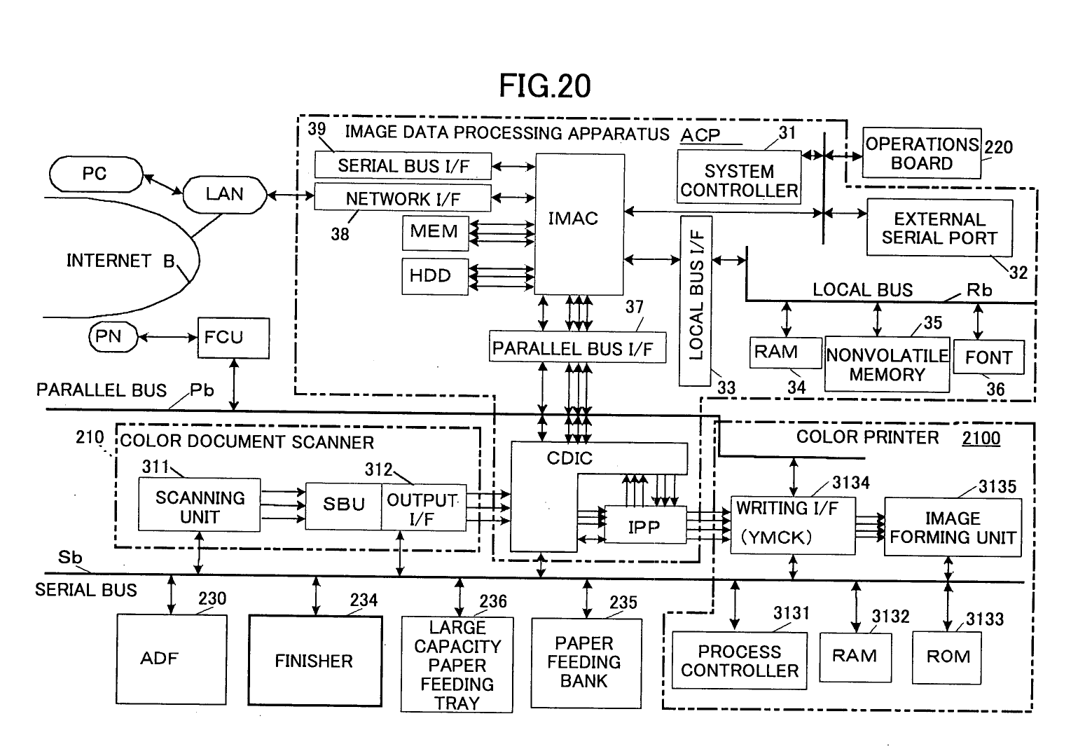

An image data processing apparatus ACP built in the MFP A1 (see FIG. 20) is connected to a LAN to which a PC is connected. A facsimile control unit FCU (see FIG. 20) is connected to a private branch exchange PBX connected to a telephone line PN (a facsimile communication channel). Printed paper output by the color printer 2100 is discharged to a paper discharging tray 2108 and the finisher 234.

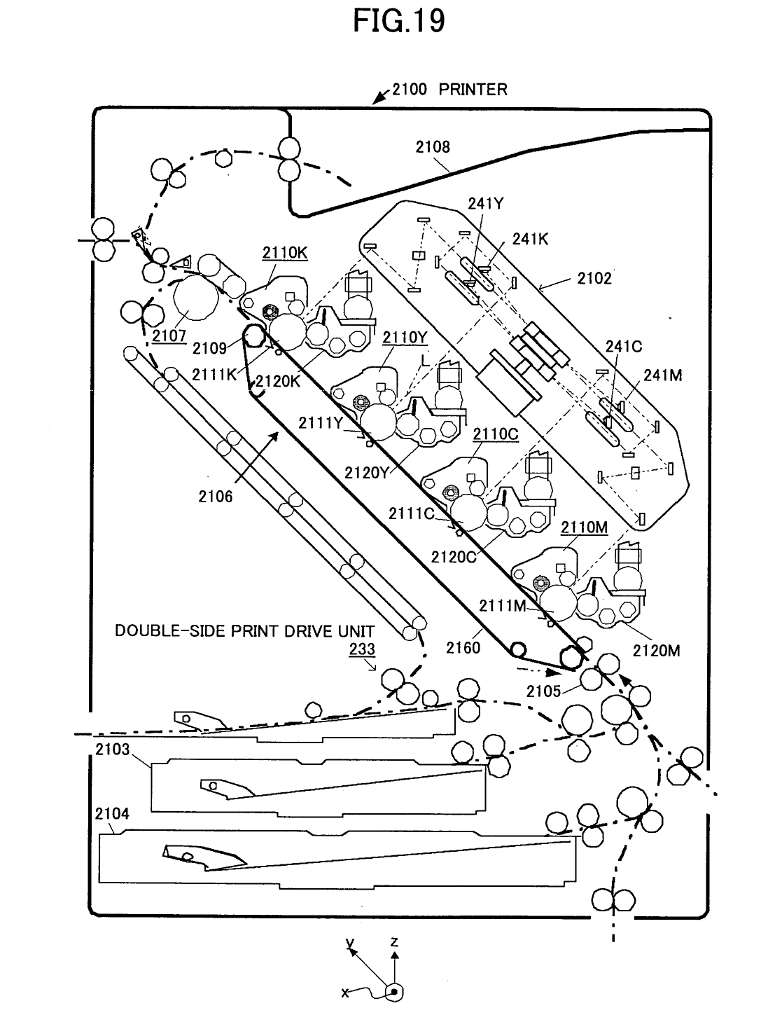

FIG. 19 shows the structure of the color printer 2100. The color printer 2100 according to this embodiment is a laser printer. This laser printer 2100 is provided with four toner image forming units for forming images of magenta (M), cyan (C), yellow (Y), and black (K). The toner image forming units are arranged in this order along the moving direction of transfer paper (the direction indicated as “y”, that is, from the right bottom to the left top in FIG. 19). The laser printer 2100 is referred to as a four drum type full color image forming apparatus.

The toner image forming units are provided with photosensitive body units 2110M, 2110C, 2110Y, and 2110K having photosensitive body drums 2111M, 2111C, 2111Y, and 2111K, and development units 2120M, 2120C, 2120Y, and 2120K, respectively. The toner image forming units are disposed in the manner in which the rotative axes of the photosensitive body drums 2111M, 2111C, 2111Y, and 2111K are parallel to a horizontal x axis (the main scan directions), and the photosensitive body drums 2111M, 2111C, 2111Y, and 2111K are separated at a predetermined distance.

The laser printer 2100 is further provided with a laser exposure unit 2102, paper feeding cassette 2103, 2104, a resist roller pair 2105, a transfer belt unit 2106, a belt fixing type fixing unit 2107, a paper discharging tray 2108, a double side drive unit 233, for example. A transfer belt 2160 provided to the transfer belt unit 2106 holds transfer paper and carries the transfer paper through the transfer position of each toner image forming unit. Although not shown, the laser printer 2100 is also provided with a hand feeder tray, a toner supply container, and trash toner bottle.

The laser exposure unit 2102 is provided with a laser diodes 241M, 241C, 241Y, 241K, a polygon mirror, f-theta lenses, and reflective mirrors. The laser exposure unit 2102 scans the surfaces of the photosensitive body drums 2111M, 2111C, 2111Y, and 2111K in the x direction with laser beams based on image data.

An alternate long and short dash line shown in FIG. 19 indicates a transportation path of transfer paper. A sheet of transfer paper fed by the paper feeding cassette 2103, 2104 is guided by a transportation guide (not shown) and transported by a transportation roller to the resist roller pair 2105. The sheet of transfer paper is output to the transfer belt 2160 at a predetermined timing by the resist roller pair 2105. The transfer belt 2160 holds the sheet of transfer paper and carries if through transfer positions of the toner image forming units.

Toner images formed on the photosensitive body drums 2111M, 2111C, 2111Y, and 2111K are transferred to the sheet of transfer paper transported by the transfer belt 2160. The toner images transferred to the sheet of transfer paper form a color image thereon. The sheet of transfer paper on which the color image is formed is transferred to the fixing unit 2107. This transferring method is referred to as a direct transfer method as the toner images are directly transferred to the sheet of transfer paper. When the sheet of transfer paper passes the fixing unit 2107, the toner image is fixed on the sheet of transfer paper. The sheet of transfer paper on which the toner image is fixed is discharged to the discharging tray 2108 or the finisher 236, or carried to the double side drive unit 233.

The yellow toner image forming unit is described below. The toner image forming unit of the other colors are structured in the same manner as the yellow toner image forming unit. As described above, the yellow toner image forming unit is provided with the photosensitive body unit 2110Y and the development unit 2120Y. Besides the photosensitive body drum 2111Y, the photosensitive body unit 2110Y is provided with a brush roller that paints lubricant on the surface of the photosensitive drum, a swingable blade that cleans the surface of the photosensitive body drum, a discharging lump that radiates light to the surface of the photosensitive body drum, non-contact charging roller that uniformly charges the surface of the photosensitive body drum, for example.

The laser exposure unit 2102 modulates the laser beam L based on print data, deflects the modulated laser beam L with the polygon mirror, and scans the surface of the photosensitive body drum 2111Y with the deflected laser beam L thereby to form an electrostatic latent image on the surface of the photosensitive body drum 2111Y. The electrostatic latent image formed on the photosensitive body drum 2111Y is developed by the development unit 2120Y thereby to form the yellow toner image. The yellow toner image formed on the photosensitive body drum 2111Y is transferred to the sheet of transfer paper held on the transfer belt 2160 at the transfer position. After the toner image is transferred, the brush roller paints a predetermined amount of lubricant on the surface of the photosensitive body drum 2111Y. The blade cleans the surface of the photosensitive body unit and the discharging lamp discharges the surface of the photosensitive body unit. The photosensitive body unit becomes ready for forming a next electrostatic latent image.

The development unit 2120Y contains two component developer including magnetic carrier and negative charging toner. The development unit 2120Y is provided with a development roller, a stirring screw, a doctor blade, a toner density sensor, and a powder pump, for example. The development roller is partially exposed from an opening provided at the side of photosensitive body drum on a development case 2120Y. The developer contained in the development case is triboelectrified by stirring by the stirring screw. A portion of the developer is retained on the surface of the development roller. The doctor blade makes the layer of developer uniformly thick. Toner in the developer retained on the surface of the development roller is transferred to the photosensitive body drum thereby to form a toner image corresponding to the electrostatic latent image on the photosensitive body drum 2111Y. The toner density sensor measures the density of toner in the developer in the development case. If the density is too low, the powder pump is activated so as to supply additional toner.

The transfer belt 2160 of the transfer belt unit 2106 is suspended in a tensioned condition by four grounded tension rollers in the manner in which the transfer belt 2160 passes the transfer positions opposite the photosensitive body drums 2111M, 2111C, 2111Y, and 2111K, respectively. One of the four tension rollers is shown with a reference numeral 2109. A electrostatic absorption roller to which a predetermined voltage is applied by a power supply is disposed opposite one of the tension rollers (entrance roller) (pointed by an alternate long and two short dashes arrow) that is disposed at the entrance of the sheet of transfer paper. The sheet of transfer paper passes between the above two rollers, and is electrostatically absorbed on the transfer belt 2160. An exit roller disposed at the downstream side is driven by a driver (not shown), and friction-drives the transfer belt. A bias roller to which a predetermined voltage is applied from the power supply is disposed contacting the outer surface of the transfer belt 2160. The bias roller removes any alien substance such as attached toner from the transfer belt 2160.

Transfer bias application members are disposed in the manner in which they contact the reverse surface of the transfer belt 2160 opposite the photosensitive body drum 2111M, 2111C, 2111Y, and 2111K. The transfer bias application member is a fixed brush made of film such as Myler (trade mark). A transfer bias voltage is applied to each transfer bias application member from a transfer bias power supply. The transfer bias application member applies a transfer bias thereby to charge the transfer belt 2160. Accordingly, a predetermined amount of electric field is formed between the transfer belt 2160 and the photosensitive body drum at each transfer position.

The sheet of transfer paper is transported by the transfer belt 2160, and toner images formed on the photosensitive body drums 2111M, 2111C, 2111Y, and 2111K are transferred to the sheet of transfer paper. The sheet of transfer paper is sent to the fixing unit 2107. The toner image is heated, pressurized, and fixed to the sheet of transfer paper. After the toner image is fixed, the sheet of transfer paper is sent to the finisher 234 through a discharge opening 234ot or discharged to the discharging tray 2108 on the top of the printer 2100.

The photosensitive body drums 2111M, 2111C, and 2111Y are driven by a single electric motor (color drum motor, not shown) via a power train and a reduction gear (both not shown) with one step slowdown. The photosensitive body drum 2111K for forming black images is driven by another single electric motor (K drum motor, not shown) via a power train and a reduction gear (both not shown) with one step slowdown. The transfer belt 2160 is driven by a transfer drive roller driven by the K drum motor via a power train. Accordingly, the K drum motor drives the photosensitive body drum 2111K and the transfer belt 2160, and the color drum motor drives the photosensitive body drums 2111M, 2111C, and 2111Y.

The K development unit 2120K is driven by a electric motor (not shown) that drives the fixing unit 2107 via a power train and a reduction gear (not shown). The M, C, Y development units 2120M, 2120C, 2120Y are driven by an electric motor (not shown) via a power train and a reduction gear (not shown). The development units 2120M, 2120C, 2120Y, 2120K are not always driven. The above reduction gears control driving of the development units 2120M, 2120C, 2120Y, 2120K at predetermined timing.

FIG. 18 is referred to again. The finisher 234 is provided with a stacker tray (stack and down tray) 234hs and a sort trays 234st. The finisher 234 operates either in a stacker discharging mode in which the sheets of paper (printed paper, transferred paper) are discharged in the stack and down tray 234hs or in a sorter discharging mode in which the sheets of paper are discharged in the sort trays 234st.

A sheet of paper sent from the printer 2100 to the finisher 234 is carried in the top left direction, and then carrying direction is changed in the downward direction by an upside-down U shaped path. In the stacker discharging mode, the sheet of paper is discharged from a discharging opening to the stack and down tray 234hs. In the sorter discharging mode, the sheet of paper is discharged to a sorter tray to which the sheet of paper is assigned.

When the sorter discharging mode is designated, a finisher discharge controller raises the sort trays 234st set in a waiting position at the bottom to a use position indicated by an alternate long and two short dashes line thereby to separate the sorter trays.

The sorter discharging mode includes a set sort mode and a page sort mode. In the set sort mode, each set of copied or printed paper is sorted in a sort tray 234st. That is, if multiple sets of documents are copied, for example, copied sets are discharged to respective sort trays 234st. In the page sort mode, each tray is assigned to a page, and multiple sheets of transfer paper on which the same image is printed are stacked in a sort tray.

FIG. 20 shows the structure of image processing system of the copier shown in FIG. 18. The color document scanner 210 including a scanning unit 312 and an image data output interface (I/F) 312 is connected to an image data interface control (CDIC) of the image data processing apparatus ACP. The color printer 2100 is also connected to the image data processing apparatus ACP. The color printer 2100 receives recording image data from an image data processing processor (IPP) of the image data processing apparatus ACP via a writing I/F 3134, and prints with an image forming unit 3135.

The image data processing apparatus ACP (hereinafter referred to as ACP) is provided with the following: a parallel bus Pb, a memory access control IMAC (hereinafter referred to as IMAC), a memory module MEM (hereinafter referred to as MEM) for storing images, a hard disk drive HDD (hereinafter referred to as HDD) as non-volatile memory, a system controller 21, RAM 34, non-volatile memory 35, Font ROM 36, CDIC, and IPP. A facsimile control unit FCU (hereinafter referred to as FCU) is connected to the parallel bus Pb. The operations board 220 is connected to the system controller 31.

The scanning unit 311 of the color document scanner 210 for optically reading documents photo-optically converts reflective light from the document with a CCD provided on a sensor board unit SBU (hereinafter referred to as SBU) thereby to generate RGB image signal. The RGB image signal is converted into RGB image data by an A/D converter. The RGB image data is processed by shading compensation, and output to CDIC via the output I/F 312.

The CDIC mediates image data transfer among the color document scanner 210 (output I/F 312), the parallel bus Pb, and IPP, and further mediates communication between the process controller 3131 and the system controller 31 that control the entire system of the ACP. The RAM 3132 is used by the process controller 3131 as an work area. The ROM 3133 stores programs that are executed by the process controller 3131.

The memory access control IMAC (hereinafter referred to as IMAC) controls reading and writing of image data and control data to/from the MEM and the HDD. The system controller 31 controls elements connected to the parallel bus Pb. The RAM 34 is used by the system controller 31 as a work area. The nonvolatile memory 35 stores programs that are executed by the system controller 31.

The operations board 220 gives the ACP operational instructions. For example, the operations board 220 informs the ACP of the kind of processing (copying, facsimile transmission, image reading, and printing, for example) and the number of copies, for example. As described above, an operator can input image data control information with the operations board 220.

The image data read by the scanning unit 311 of the scanner 210 is processed with shading adjustment by the SBU, and then further processed with scanner gamma adjustment and filter processing, for example, thereby to adjust distortion caused by scanning. The adjusted image data is stored in the MEM or the HDD. When image data stored in the MEM or the HDD is printed, the RGB signal is converted into a YMCK signal by the IPP, and then, the YMCK signal is processed with print gamma conversion, gray shade conversion, gray shade processing such as dithering or error diffusion processing. The processed image data is transferred from the IPP to the writing I/F 3134. The writing I/F 3134 controls the pulse width and the power of laser beam based on the gray-scale processed signal. The image data is transferred to the image forming unit 3135 that reproduces image on the transfer paper.

The IMAC controls the access to the image data stored in the MEM or the HDD, expands data transmitted from the personal computer PC (hereinafter referred to as PC) connected to the LAN for printing, and compress and decompress image data for efficient use of the memory capacity of the MEM and the HDD.

The image data transmitted to the IMAC is compressed and stored in the MEM or the HDD. The stored image data is retrieved, if necessary. The retrieved image data is decompressed thereby to reproduce original image data, and sent to the CDIC from the IMAC via the parallel bus Pb. The image data is further transferred from the CDIC to the IPP, and is processed with image quality processing. The processed image data is output the the writing I/F 3134. The image forming unit 3135 reproduces the image on the transfer paper.

The parallel bus Pb and the bus control by the CDIC realizes the multiple functions of the digital multiple functional peripheral. A facsimile transmission is realized by processing a scanned image by the IPP and transferring the processed scanned image to the FCU via the CDIC and the parallel bus Pb. The FCU converts the image data into facsimile data and transmits the facsimile data to the public network PN. A facsimile reception is realized by converting facsimile data received from the public network PN into image data by the FCU and transmitting the image data to the IPP via the parallel bus Pb and the CDIC. In this case, no special image quality processing is performed on the image data. The writing I/F 3134 outputs the image data, and the image forming unit 3135 reproduces the image on transfer paper.

In the case that a plurality of jobs such as the copying function, the facsimile transmission/reception function, and the printer output function are performed in parallel, the system controller 31 and the process controller 3131 allocates the use rights of the scanning unit 311, the image forming unit 3135, and the parallel bus Pb to the jobs. The process controller 3131 controls the flow of image data. The system controller 31 controls the entire system, and controls the activation of resources. Functions of the digital multi functional peripheral is selected using the operational board 220. An operator can set the contents of processing such as the copy function and the facsimile function by inputting a selection to the operations board 220.

The system controller 31 and the process controller 3131 mutually communicates via the parallel bus Pb, the CDIC, and the serial bus Sb. Specifically, the CDIC mediates the communication between the system controller 31 and the process controller 3131 by converting data format between the parallel bus Pb and the serial bus Sb.

Various bus interfaces such as the parallel bus I/F 37, the serial bus I/F 39, the local bus I/F 33, and the network I/F 38 are connected to the IMA. The controller unit 31 is connected to related units of the ACP via various busses so as to keep the controller unit 31 independent from them.

The system controller 31 controls the other functional units via the parallel bus Pb. The parallel bus Pb is also used fro transferring the image data. The system controller 31 causes the IMAC to store the image data in the MEM and the HDD by giving an operational control instruction. This operational control instruction is transferred via the IMAC, the parallel bus I/F 37, the parallel bus Pb.

The CDIC, in response to the operational control instruction, sends the image data to the IMAC via the parallel bus Pb and the parallel bus I/F 37. The IMAC stores the image data in the MEM or the HDD.

When the PC requests the multi functional peripheral to function as a printer, the system controller 31 of the ACP functions as a printer controller, a network controller, and a serial bus controller. In the case that the request is transmitted via the network B, the IMAC receives the request for printing data or the request for storing data via the network and the network I/F 38. The request (incoming command) received via the network B is informed to the system controller 31. The IMAC transmits the data to be stored or stores the data in accordance to a command issued by the system controller 31 in response to the request.

In the case of a general purpose serial bus connection, the IMAC receives the print request data via the serial bus I/F 39. The general purpose serial bus I/F 39 complies with a plurality of kinds of standards such as the Universal Serial Bus (USB), IEEE 1284, and/or IEEE 1394.

The print request data from the PC is expanded by the system controller 31 into image data in a memory are in the MEM. Font data needed for the expansion is provided by the Font ROM 36 via the local bus I/F 33 and the local bus Rb. The local bus Rb connects the controller 31 to the nonvolatile memory 35 and the RAM 34.

Beside an external serial port 32 for the connection with the PC, there is an interface between the serial bus Sb and the operations board 220 that is an operations unit of the ACP. The operations board 220 communicates with the system controller 31 via the IMAC, and accepts user's instruction and displays the state of the system.

The system controller 31, the MEM, the HDD, and the various buses communicates via the IMAC. Jobs that use the MEM and the HDD are centrally controlled in the entire ACP.

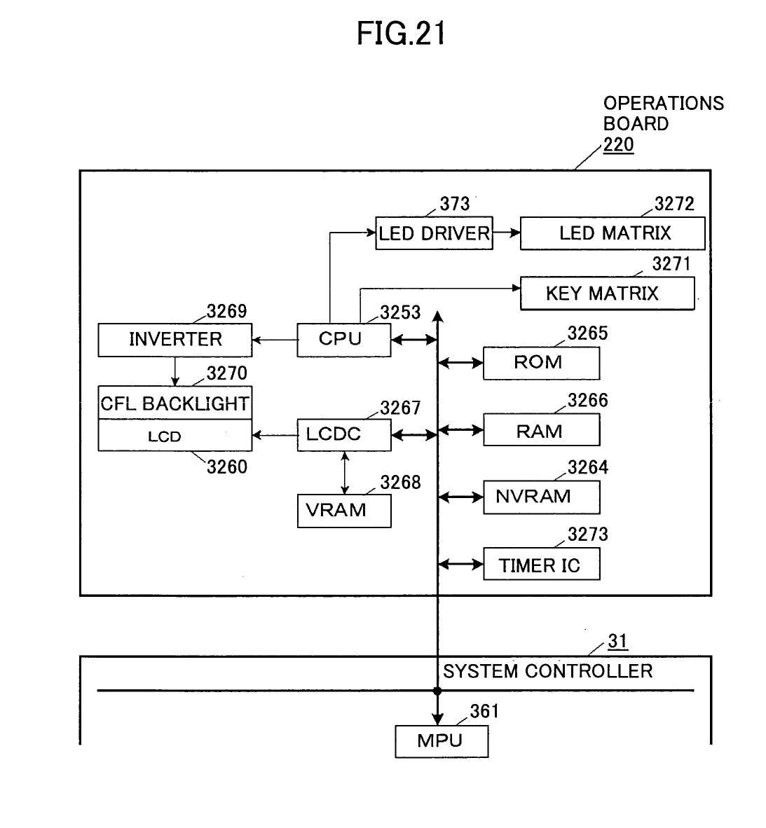

FIG. 21 is a block diagram showing the circuit of the operations board 220. The operations board 220 is provided with the following: a liquid crystal touch panel (hereinafter referred to as a liquid crystal display or display) 379, an operations key matrix 3271, and light emitting diode (LED) 3272. The liquid crystal display 379 has an input function as well as a display function. The key matrix 3271 has a power key that switches a power save mode (sleeping mode or low power consumption mode) and a stand-by mode. When the power key is pressed once in the power saving mode, the mode is switched from the power saving mode to the stand-by mode. When the power key is pressed once in the stand-by mode, the mode is switched from the stand-by mode to the power saving mode.

The control circuit of the operations board 220 shown in FIG. 21 includes the following: a CPU 3253, ROM 3265, RAM 3266, VRAM 3268, a liquid crystal display controller (LCDC) 3267, and a timer 3273. The CPU 3253 communicates with the MPU 361 of the system controller 31, reads the input to the operations board 220, and controls the display on the operations board 220. The ROM 3265 stores the control programs of the CPU 3253. The RAM 3266 temporarily stores data. The VRAM 3268 stores the image data of the LCD 379. The liquid crystal display controller 3267 is connected to the VRAM 3268, and controls the timing for imaging of the LCD 3260. The timer 3273 generates clock data. The LCD 3260 has a CFL light source as a backlight 3270 and is connected to the LCDC 3267. An inverter 3269 that drives the CDL backlight 3270, a key matrix 3271, an LED matrix 3272, and an LED driver 373, for example, are connected to the CPU 3253.

A nonvolatile RAM (NVRAM) 3264 for storing image processing mode, state information, and use records is connected to the data bus to which the CPU 3253 is connected.

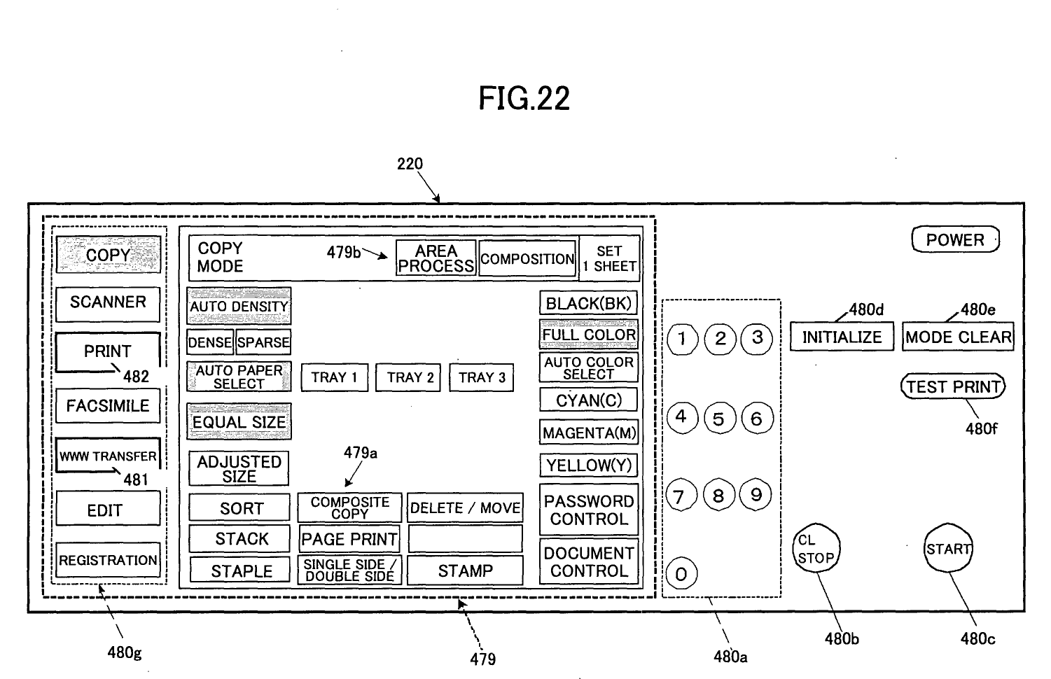

As shown in FIG. 22, the operations board 220 is provided, beside the liquid crystal touch panel 479, with the following: a ten key 480a, a clear/stop key 480b, a start key 480c, an initialization setting key 480d, a mode clear key 480e, a test print key 480f.

When the test print key 480f is pressed, only a set of documents is printed despite the number of sets designated. The operator can check the result of printing. The operator can customize the initial state of the system by pressing the initialization setting key 480d. The operator can set the paper size to be stored in the system, and set the state to which the system returns when the reset key is pressed. When the initialization setting key 480d is pressed, a menu including “initial parameter setting” function for setting various initial parameters, “ID setting” function, “copy right registration/setting” function, and “use record outputting” function is displayed. The operator can select an application that is, if no operation is made for a predetermined time period, activated at a priority. It is possible to set the time for transiting to a low power consumption mode in compliance with the international energy star, and the time for transiting to auto off/sleep mode.

In the liquid crystal touch panel 479, messages indicating the state of various functional keys and the multi functional peripheral are displayed. Function selection keys 480g for selecting a function such as “copy” function, “scanner” function, “printer” function, “facsimile” function, “www transfer” function, “edit” function, “registration” function are also shown in the liquid crystal touch panel 479. An input/output screen corresponding to the function selected by the function selection key 480g is displayed in the liquid crystal touch panel 479. As shown in FIG. 22, when “copy” function is selected, for example, function keys 479a, 479b and messages indicating the number of sets and the state of the multi functional peripheral are displayed. When the operator touches a key displayed in the liquid crystal touch panel 479, the touched key turns to gray. If specific items needs to be set (the kind of page print, for example), when the operator touches a key, the screen for setting the specific items is displayed. As described above, since a dot matrix display is employed as the liquid crystal touch panel 479, the system can communicate with the operator through graphical user interface.

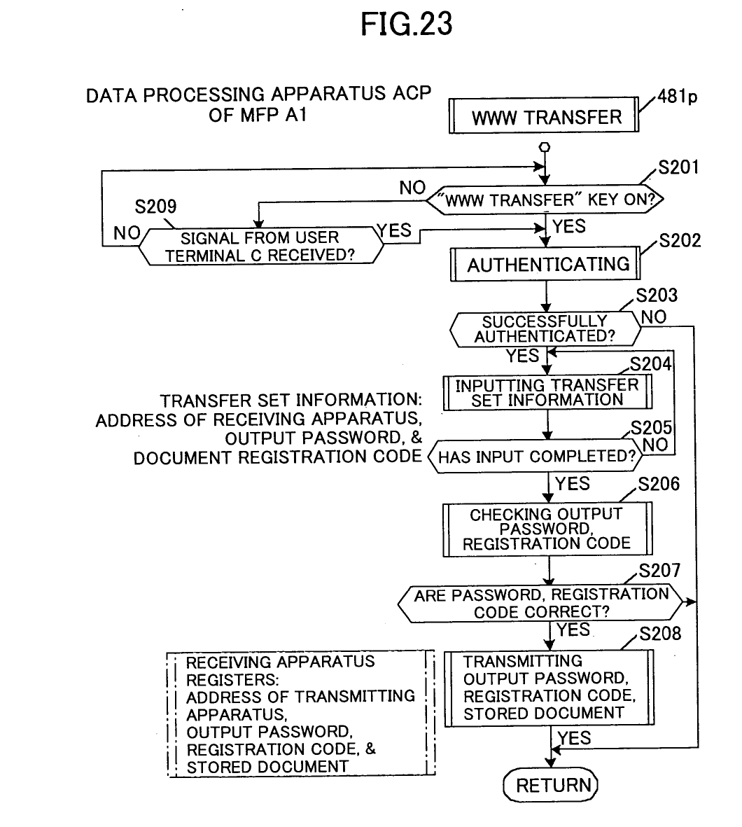

When the “www transfer” key 481 in the function selection keys 480g is pressed, or a command for transmitting a stored document is sent from the user terminal C, the system controller 31 of the ACP, in cooperation with the IMAC, transmits the stored document. The transmission operation is explained with reference to FIG. 23.

When the “www transfer” key 481 is pressed by a user, the system controller 31 displays an input screen for requesting the user to input a user code on the liquid crystal panel 479 of the operations board 220. When the user code is input, a determination is made whether the input user code is registered (steps S201, S202).

If the input user code is registered, the system controller 31 displays an input screen for requesting for transfer set information (step S204). The transfer set information includes (1) address of receiving apparatus (for example, the Internet address of the MFP A2), (2) an output password that permits printing of the stored document, and (3) document registration code of the stored document (stored in the MEM or the HDD). When the above items are input, the system controller 31 determines whether the inputted output password is correct by searching it in the passwords for outputting the stored document. The system controller 31 further determines whether there is a stored document in the MEM or the HDD corresponding to the input document registration code (step S205-207). If both determinations are positive, the output password, the document registration code, and the stored document corresponding to the document registration code are transmitted to the address of the receiving apparatus (step S208). The receiving MFP A2 (image forming apparatus) receives and stores the address of the transmitting apparatus (the Internet address of the transmitting MFP A1, for example), the output password, the document registration code, and the stored document in the HDD of the ACP of the MFP A2.

When a command for transmitting a stored document from the user terminal C (step S209), the system controller 31 operates in the same manner as the case that the “www transfer” key 481 is pressed. In this case, however, an input screen is transmitted to the user terminal C instead of displaying the input screen on the liquid crystal touch panel 479 of the operations board 220, and input data is received from the user terminal C instead of the user inputting data through the input screen.

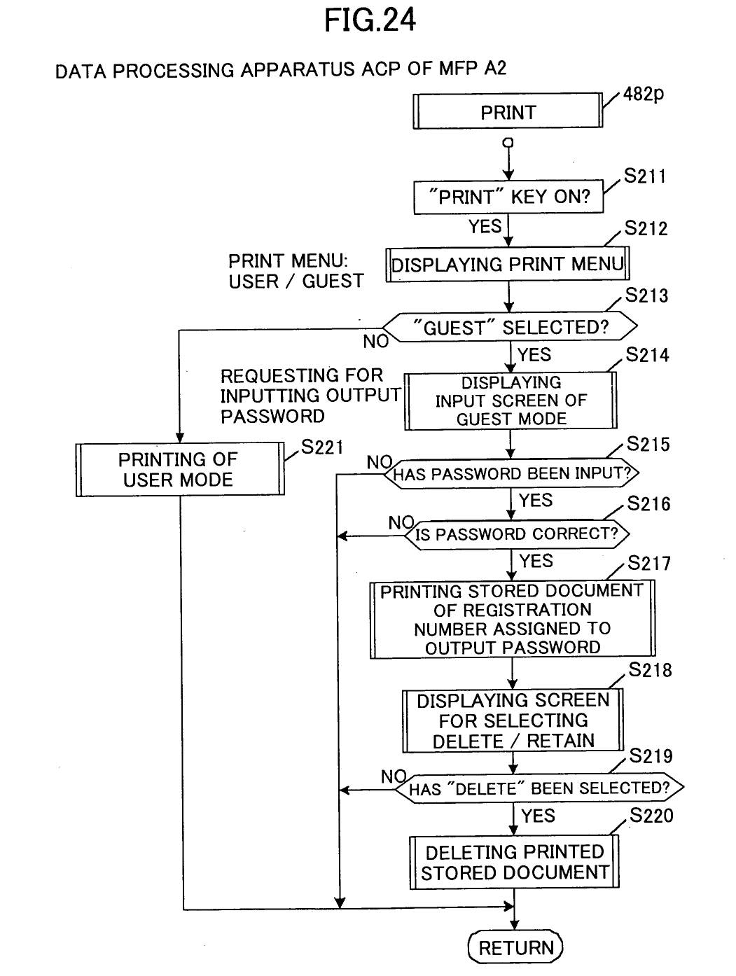

When a receiving user inputs the output password into the MFP A2, the MFP A2 prints the stored document. The system controller 31 of the MFP A2 operates in the same manner as the system controller 31 of the MFP A1. FIG. 24 is a flow chart showing print processing of the system controller 31 of the MFP A2.

When the “print” key 482 in the function selection keys 480g in the liquid crystal touch panel 479 is pressed, the system controller 31 displays a print menu for requesting the user to select “user mode”, “guest mode”, and other modes in the liquid crystal touch panel 479 (steps S211, 212). If the user selects “guest mode”, the system controller 31 displays an input screen for requesting the user to input the output password in the liquid crystal panel 479 (steps S213, 214). In response to the input of the output password, the system controller 31 determines whether the inputted output password is correct by searching the inputted output password in the HDD of the ACP. If a determination is made that the output password is correct, the system controller 31 reads the stored document corresponding to the document registration code assigned to the correct output password from the HDD, and prints the stored document using the printer 2100 (step S216, 217).

After completing to print the stored document, the system controller 31 displays a screen for selecting the deleting or storing of the stored document on the liquid crystal panel 479, and waits for user's input (step S218, 219). If deleting is selected, the system controller 31 deletes the stored document and related information such as the output password and the document registration code from the HDD (step S220).

If the operator selects “user mode” from the print menu, the system controller 31 displays another print input screen and request the operator to his/her user ID and related information. If the operator is successfully identified as a registered user of the MFP A2, the operator can print the stored document using the user mode functions (step S221).

[Fifth Embodiment]

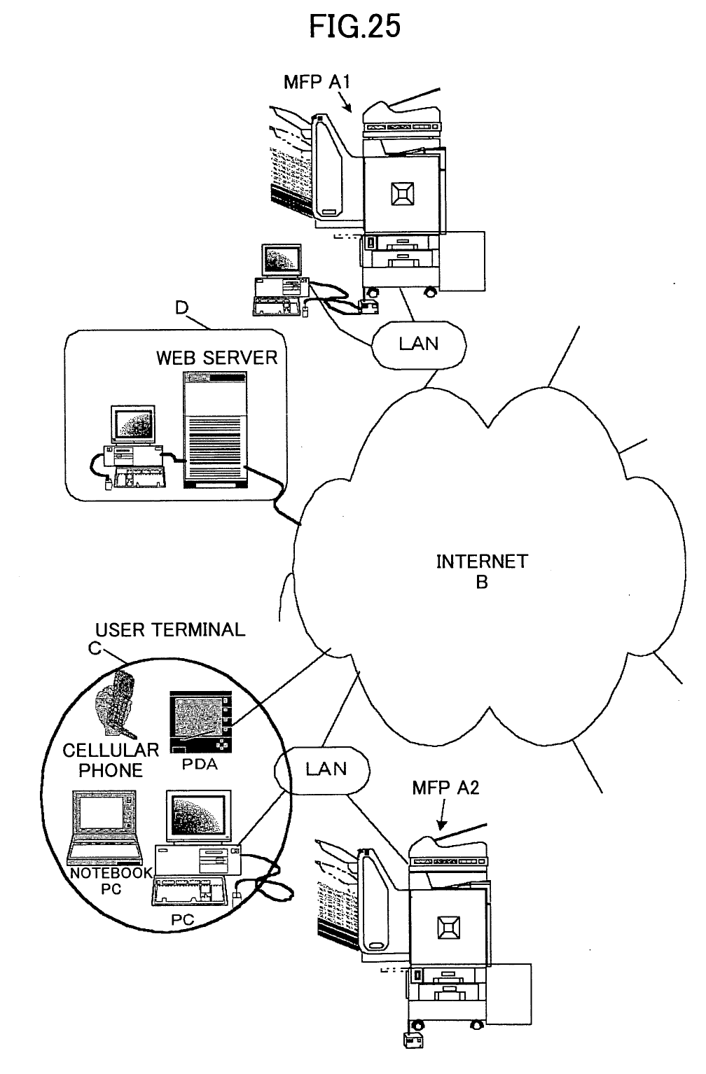

FIG. 25 shows an image forming system according to a fifth embodiment of the present invention. It is noted that a network server D is additionally connected to the Internet B. The network server D is a server operated by an information storage service provider or a contents provider, for example. The network server D stores files and data of customers, informs the customers that another file is stored, and transfers the stored file and data to addresses designated by the customers.

The hardware of the MFPs A1 and A2 (image forming apparatuses) is the same as the fourth embodiment shown in FIG. 17. The software of the MFPs A1 and A2 is almost identical to that of the fourth embodiment, but is different in that, since the server D functions as a relay station among the MFP A1, the user terminal C, and the MFP A2, the communication operation of the MFPs A1 and A2 is slightly different from that of the fourth embodiment.

The MFPs A1 and A2 are assumed to be multi functional color copiers having the same structure and the same function that can mutually communicate via a local area network (LAN) and the Internet B. The MFPs A1 and A2 also can communicate with the user terminals C such as a personal computer PC, a notebook PC, a personal digital assistant (PDA), and a mobile phone. The structure and function of the MFPs A1 and A2, however, may be different as long as they can operate as described in this specification.

According to an embodiment, the MFP A1 stores documents (stored documents) such as image data acquired by a scanner and a digital camera, image data created by computer graphics and CAD, document data created by a word processor, and facsimile data. When a user needs to access a stored document but is far from the MFP A1, the user accesses the MFP A1 using a user terminal C via the Internet B, and request the MFP A1 to transmit the stored document to the server D. The MFP A2, in response to the request, transmits the designated stored document with the address of the user terminal C in the Internet B and an output password to access the stored document, to the server D via the Internet B. The server D, in response to reception of the stored document, the address of the user terminal C, and the output password, registers the received data, and transmits the password to the user terminal C.

When a user inputs the output password and the address of the server D to the MFP A2, the MFP A2 transmits the output password to the server D. The server D, in response to reception of the output password, transmits a stored document related to the output password to the MFP A2. The MFP A2 prints the stored document received from the server D.

According to another embodiment, a user operates an operations board of the MFP A1 (image forming apparatus) that stores the stored document thereby to transmit the stored document to the server D. The server D transmits the stored document to the MFP A2, and the MFP A2 outputs (print) the stored document in the same manner as described above.

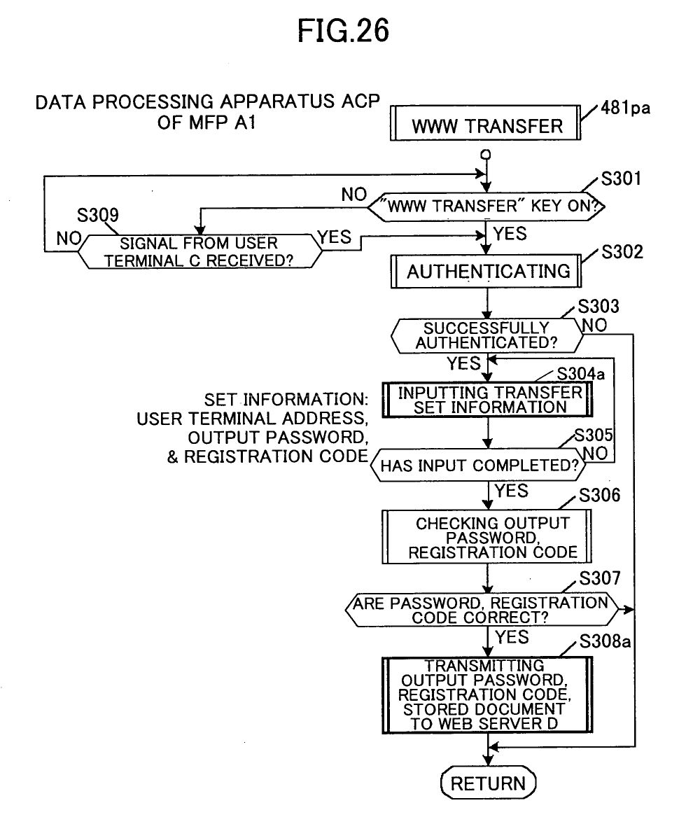

When the “www transfer” key 481 in the function selection keys 480g is pressed, or a command for transmitting a stored document is sent from the user terminal C, the system controller 31 of the ACP, in cooperation with the IMAC, transmits the stored document. The transmission operation is explained with reference to FIG. 26.

When the “www transfer” key 481 is pressed by the user, the system controller 31 displays an input screen for requesting the user to input a user code on the liquid crystal panel 479 of the operations board 220. When the user code is input, a determination is made whether the input user code is registered (steps S301, S302).

If the input user code is registered, the system controller 31 displays an input screen for requesting for transfer set information (step S304a). The transfer set information includes (1) address of user terminal C, (2) an output password that permits printing of the stored document, and (3) document registration code of the stored document (stored in the MEM or the HDD). When the above items are input, the system controller 31 determines whether the inputted output password is correct by searching the inputted output password in the passwords for outputting the stored document. The system controller 31 further determines whether there is a stored document in the MEM or the HDD corresponding to the input document registration code (step S305-307). If both determinations are positive, the address of the user terminal C, the output password, the document registration code, and the stored document corresponding to the document registration code are transmitted to the server D (step S308a).

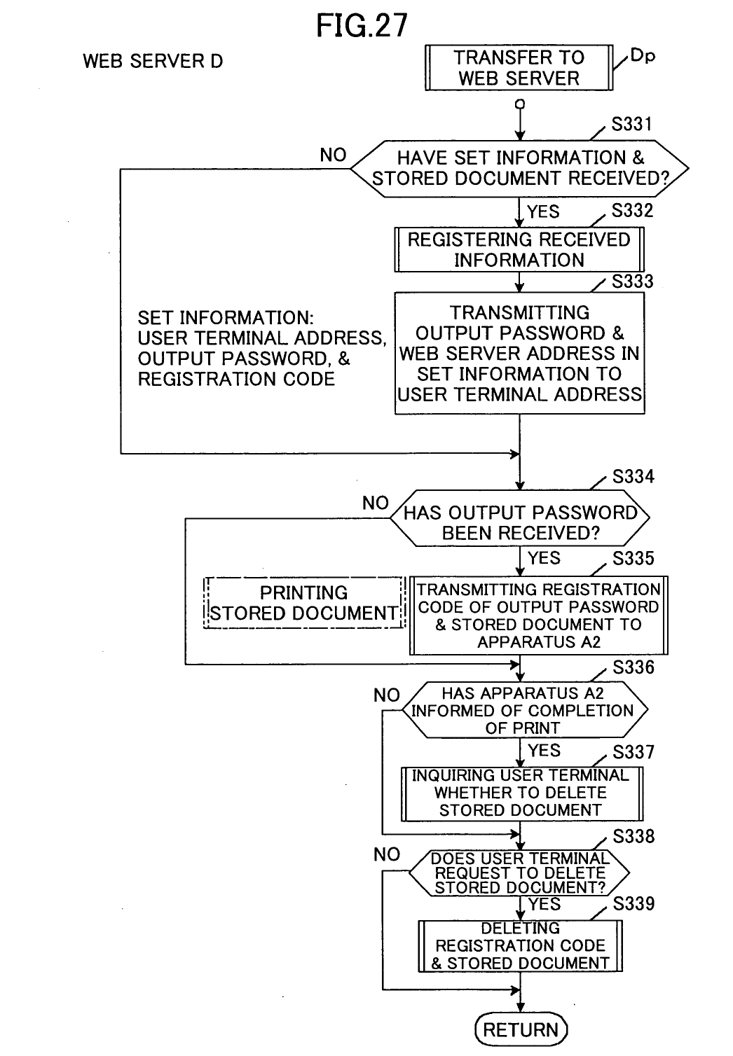

FIG. 27 is a flow chart showing the receiving operation of the server D. The server D, in response to reception of the set information (the address of the user terminal C, the output password, and the document registration code) and the stored document, registers the received information to an HDD of the server D (steps S331, 332). The server D transmits the output password and the address of the server D to the user terminal C (step S333). The user terminal C stores the received information therein.

When a command for transmitting a stored document from the user terminal C (step S309), the system controller 31 operates in the same manner as the case that the “www transfer” key 481 is pressed. In this case, however, an input screen is transmitted to the user terminal C instead of displaying the input screen on the liquid crystal touch panel 479 of the operations board 220, and input data is received from the user terminal C instead of the user inputting data through the input screen.

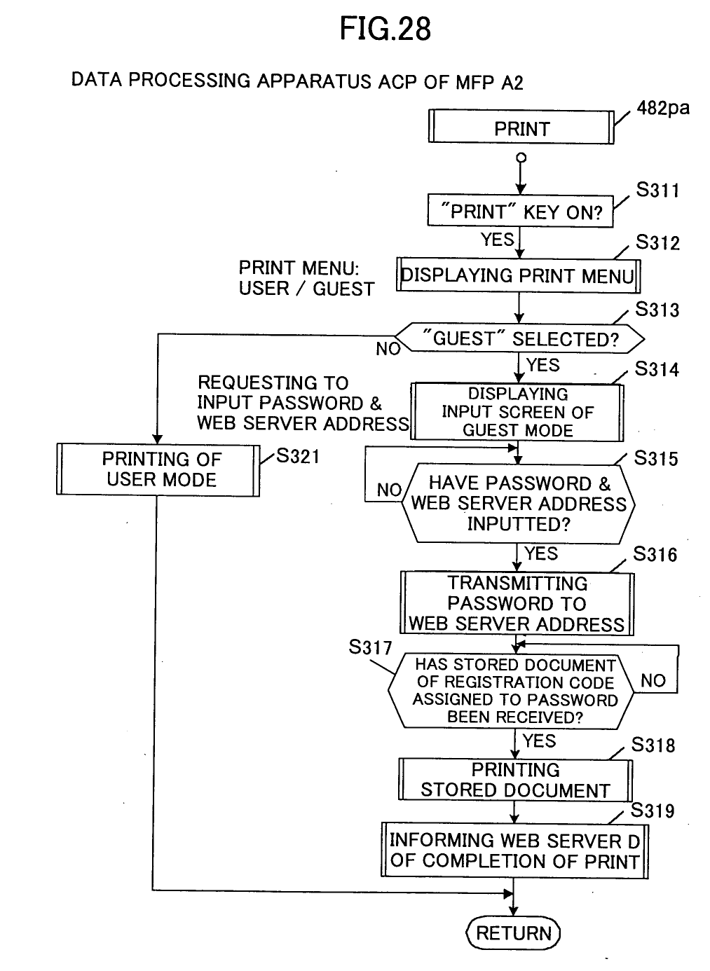

When a receiving user inputs the output password and the address of the server D into the MFP A2, the MFP A2 prints the stored document. The system controller 31 of the MFP A2 operates in the same manner as the system controller 31 of the MFP A1. FIG. 28 is a flow chart showing print processing of the system controller 31 of the MFP A2.

When the “print” key 482 in the function selection keys 480g in the liquid crystal touch panel 479 is pressed, the system controller 31 displays a print menu for requesting the user to select “user mode”, “guest mode”, and other modes in the liquid crystal touch panel 479 (steps S311, 312). If the user selects “guest mode”, the system controller 31 displays an input screen for requesting the user to input the output password and the address of the server D in the liquid crystal panel 479 (steps S313, 314a). In response to the input of the output password and the address of the server D, the system controller 31 transmits the output password to the address of the server D (step S315, 316).

Referring to FIG. 27, the server D, in response to the output password, transmits the document registration code corresponding to the received output password and the stored document to the MFP A2 (step S334, 335).

Referring to FIG. 28 again, the system controller 31 of the ACP of the MFP A2 prints the stored document received from the server D (step S316, 317), and informs the server D of the completion of printing the stored document (step S319).

Referring to FIG. 27 again, the server D, in response to reception of information indicating the completion of printing the stored document, sends a query whether to delete the stored document corresponding to the output password (steps S336, 337). If the user terminal C requests to delete the stored document, the server D deletes the set information and the stored document from the HDD (step S338, 339).

[Variation of Fifth Embodiment]

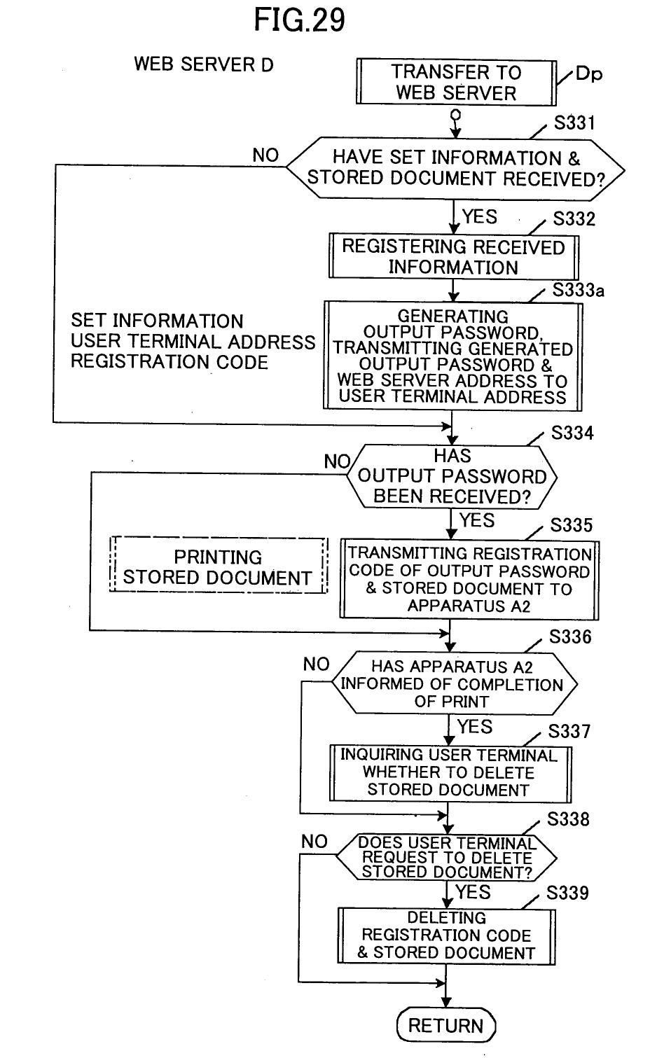

According to the above fifth embodiment, the MFP A1, in response to user's operation, transmits an output password for accessing a stored document to the server D, and the server D transmits the same output password to the user terminal C. However, the server D may generates an output password and transmit the generated output password to the user terminal C. In this case, the information item included in the set information can be reduced. The transmitting user does not need to input the output password to the MFP A1. The operational flow of the server D is shown in FIG. 29.

The server D, in response to reception of set information (the address of the user terminal C and the document registration code) and the stored document, stores them in an HDD of the server D (step S331, 332). The server D generates an output password for accessing the stored document, and transmits the generated output password and the address of the server D to the user terminal C (step S333a). The user terminal C stores the output password and the address received from the server D. Since the remaining steps of the MFP A2 and the user terminal C are the same as those of the above fifth embodiment, their description is omitted.

The present invention is not limited to these embodiments, but variations and modifications may be made without departing from the scope of the present invention.

This patent application is based on

Japanese priority patent application No. 2002-260430 filed on Sep. 5, 2002, and No. 2002-334007 filed on Nov. 18, 2002, No. 2003-310252 filed on Sep. 2, 2003, the entire contents of which are hereby incorporated by reference.

What is claimed is:

1. A file transfer system, comprising:
a file management server;
a file transmitting terminal; and
a file receiving terminal;
wherein
said file management server, said file transmitting terminal, and said file receiving terminal are connected each other via a network;
said file transmitting terminal transmits to said file management server a file and a corresponding authorization condition for accessing said file;
said file management server stores said file and said corresponding authorization condition transmitted from said file transmitting terminal;
said file receiving terminal transmits to said file management server a request for transferring said file; and
said file management server, in response to said request transmitted by said file receiving terminal, if said corresponding authorization condition stored therein is satisfied, transfers the file to said file receiving terminal.

2. The file transfer system as claimed in claim 1, wherein
said authorization condition corresponding to said file is a password for accessing said file; and
said file management server, if a password transmitted with said request by said file receiving terminal matches said password transmitted by said file transmitting terminal, transmits said file to said file receiving terminal.

3. The file transfer system as claimed in claim 1, wherein
said authorization condition is one or more user IDs that are authorized to access said file; and
said file management server, if a user ID transmitted with said request by said file receiving terminal is included in said one or more user IDs transmitted by said file transmitting terminal, transmits said file to said file receiving terminal.

4. The file transfer system as claimed in claim 1, wherein
said authorization condition is the membership of a group that is authorized to access said file; and
said file management server, if a user ID transmitted with said request by said file receiving terminal is a member of said group, transmits said file to said file receiving terminal.

5. The file transfer system as claimed in claim 1, wherein
said file transmitting terminal transmits an effective period corresponding to said file;
said file management server stores the corresponding effective period with said file; and
said file management server, if the corresponding effective period has expires, prohibits said file from being transmitted.

6. The file transfer system as claimed in claim 5, wherein said file management server, if the corresponding effective period has expired, deletes said file.

7. The file transfer system as claimed in claim 1, wherein
said file transmitting terminal transmits an effective number of transfers corresponding to said file;
said file management server stores the corresponding effective number of transfers with said file; and
said file management server, if the number of transfers of said file reaches the corresponding effective number of transfers, prohibits said file from being transmitted.

8. The file transfer system as claimed in claim 7, wherein said file management server, if the number of transfers of said file reaches the corresponding effective number of transfers, deletes said file.

9. The file transfer system as claimed in claim 1, further comprising a user terminal connected to said file management server via said network;
wherein
said user terminal acquires the address of said file receiving terminal and transmits the address to said file management server;
said file management server stores the address of said file receiving terminal transmitted from said user terminal and; and
said file management server, in response to said request for transmitting said file from said file receiving terminal, if the address of said file receiving terminal match the stored address.

10. The transfer system as claimed in claim 1, wherein said file receiving terminal prints or stores, in a recording medium, said file received from said file management server.

11. A file management server connected to a file transmitting terminal and a file receiving terminal via a network, comprising:
a communication unit that exchanges data with an external apparatus via said network;
a first storage unit that stores a file and an authorization condition for accessing said file related each other; and
a file transferring unit that, in response to a request for transferring said file stored in said first storage unit from said file receiving terminal, if said authorization condition is satisfied, transfers said file to said file receiving terminal.

12. The file management server as claimed in claim 11, wherein
said authorization condition corresponding to said file is a password for accessing said file; and
said file transferring unit, if a password transmitted with said request matches said password stored in said first storage unit, transfers said file to said file receiving terminal.

13. The file management server as claimed in claim 11, wherein
said authorization condition corresponding to said file is one or more user IDs; and
said file transferring unit, if a user ID transmitted with said request is included in said one or more user IDs stored in said first storage unit, transfers said file to said file receiving terminal.

14. The file management server as claimed in claim 11, further comprising a second storage unit that stores group name and user IDs of group members;
wherein
said authorization condition stored in said first storage unit is said group name; and
said file transferring unit, if a user ID transmitted with said request is included in said group members, transfers said file to said file receiving terminal.

15. The file management server as claimed in claim 11, wherein
said first storage unit further stores the effective period of said file; and
said file transfer unit, if the effective period of said file has expired, avoids transferring said file to said file receiving terminal.

16. The file management server as claimed in claim 15, wherein said file transferring unit, if the effective period of said file has expired, deletes said file.

17. The file management server as claimed in claim 11, wherein
said first storage unit further stores the effective number of transfers of said file; and
said file transfer unit, if the number of transfers of said file reaches the effective number stored in said first storage unit, avoids transferring said file to said file receiving terminal.

18. The file management server as claimed in claim 17, wherein said file transferring unit, if the number of transfers of said file reaches the effective number, deletes said file.

19. The file management server as claimed in claim 14, wherein
said second storage unit stores the address of said file receiving terminal transmitted from a user terminal, and
said file transferring unit, in response to a request for transferring said file, said request transmitted from said file receiving terminal, only if the address of said file receiving terminal matches the address stored in said first storage unit, transmits said file to said file receiving terminal.

20. A file transfer method, comprising the steps of:
receiving a file and an authorization condition for accessing said file transmitted by a file transmitting terminal;
storing said file and said authorization condition transmitted by said file transfer terminal;
receiving a request for transmitting said file designated from a file receiving terminal;
determining, in response to said request, whether said authorization condition is satisfied; and
transmitting, if said authorization condition is satisfied, said file to said file receiving terminal.

21. A computer program that causes a computer to perform the steps of:
receiving a file and an authorization condition for accessing said file transmitted by a file transmitting terminal;
storing said file and said authorization condition transmitted by said file transfer terminal;
receiving a request for transmitting said file designated from a file receiving terminal;
determining, in response to said request, whether said authorization condition is satisfied; and
transmitting, if said authorization condition is satisfied, said file to said file receiving terminal.

22. An image forming system, comprising:
a stored document management server;
a first image forming apparatus that stores a stored document; and
a second image forming apparatus;
wherein
said stored document management server, said first image forming apparatus, and said second image forming apparatus are connected each other via a network;
said first image forming apparatus transmits to said stored document management server said stored document and an authorization condition for accessing said stored document;
said file management server stores the transmitted stored document and the transmitted authorization condition relating each other;
said second image forming apparatus transmits to said stored document management server a request for transferring the stored document; and
said stored document management server, in response to said request transmitted by said second image forming apparatus, if the stored authorization condition is satisfied, transfers the stored document to said second image forming apparatus.

23. A stored document management server connected to a first image forming apparatus and a second image forming apparatus via a network, comprising:
a communication unit that exchanges data with said first and second image forming apparatuses via said network;
a first storage unit that stores a stored document and an authorization condition for accessing said stored document related each other; and
a stored document transferring unit that, in response to a request for transferring said stored document stored in said first storage unit from a second image forming apparatus, if said authorization condition is satisfied, transfers said stored document to said image forming apparatus.

24. An image forming system, comprising:
a first image forming apparatus;
a user terminal; and
a second image forming apparatus;
wherein
said first image forming apparatus, said user terminal, and said second image forming apparatus are connected each other via a network;
said first image forming apparatus stores a stored document and an authorization condition for accessing said stored document relating each other and, in response to a request from said user terminal, if said authorization condition is satisfied, transmits said stored document and said authorization condition to said second image forming apparatus; and
said second image forming apparatus stores said stored document and said authorization condition relating each other and, if said authorization condition is satisfied, prints said stored document.

25. An image forming system, comprising:
a first image forming apparatus;
a stored document management server;
a user terminal; and
a second image forming apparatus;
wherein
said first image forming apparatus, said stored document management server, said user terminal, and said second image forming apparatus are connected each other via a network;
said first image forming apparatus stores a stored document and an authorization condition for accessing said stored document relating each other and, in response to a request from said user terminal, if said authorization condition is satisfied, transmits said stored document and said authorization condition to said stored document management server;
said stored document management server stores said stored document and said authorization condition transmitted from said first image forming apparatus relating each other and, in response to a request for transmitting said stored document from said second image forming apparatus, if said authorization condition for accessing said stored document is satisfied, transmits said stored document to said second image forming apparatus; and
said second image forming apparatus prints said stored document transmitted from said stored document management server.

26. An image forming apparatus connected with another image forming apparatus via a network, comprising:
a communication unit that exchanges data via said network;
a storage unit that stores a stored document and an authorization condition for accessing said stored document received said other image forming apparatus relating each other;
an operations input unit;
an image forming unit that, in response to reception of a request for printing said stored document, if said authorization condition for accessing said stored document is satisfied, prints said stored document.

27. The image forming apparatus as claimed in claim 26, wherein
said image forming apparatus is further connected to a user terminal via said network; and
said communication unit, in response to a transfer request from said user terminal, is said transfer request satisfies said authorization condition, transmits said stored document and said authorization condition stored in said storage unit to a destination.

28. The image forming apparatus as claimed in claim 26, wherein said transfer request includes said destination, a password as said authorization information for accessing said stored document, and a registration code of said stored document that said communication unit has received from said user terminal via said network.

29. The image forming apparatus as claimed in claim 26, wherein said transfer request includes said destination, said authorization condition for accessing said stored document, and a registration code of said stored document that are input by said operations input unit.

30. An image forming apparatus connected with a stored document management server and a user terminal via a network, comprising:
a communication unit that exchanges data via said network;
a storage unit that stores a stored document and an authorization condition for accessing said stored document relating each other; and
an image forming unit that prints said stored document;
wherein
said communication unit, in response to reception of a request for transmitting said stored document from said user terminal, if said request satisfies said authorization condition stored in said storage unit, transmits said stored document and said authorization condition to said stored document management server.
